(19) United States
(12) Patent Application Publication
(10) Pub. No.: US 2011/0037406 A1
(43) Pub. Date: Feb. 17, 2011

(54) HIGH PRESSURE DISCHARGE LAMP LIGHTING APPARATUS AND LIGHTING FIXTURE

(76) Inventors: Nobutoshi Matsuzaki, Neyagawa-shi (JP); Takeshi Kamoi, Kyoto-shi (JP); Takeshi Goriki, Yawata-shi (JP); Daisuke Yamahara, Shijonawate-shi (JP)

Correspondence Address: Cheng Law Group, PLLC, 1100 17th Street, N.W., Suite 503, Washington, DC, 20036, US

(21) Appl. No.: 12/989,197

(22) PCT Filed: Apr. 6, 2009
(86) PCT No.: PCT/JP2009/057059

§ 371 Date: Oct. 22, 2010

(30) Foreign Application Priority Data
Apr. 24, 2008 (JP) 2008-114635
Apr. 24, 2008 (JP) 2008-114636
Apr. 24, 2008 (JP) 2008-114637

(51) Int. Cl. H05B 41/36

(52) U.S. Cl. 315/276; 315/287

(57) ABSTRACT

The high pressure discharge lamp lighting apparatus (10) includes a power circuit (20, 30, 40, and 50) and a starting circuit (60). The power circuit (20, 30, 40, and 50) includes a pair of output terminals (55 and 56) adapted to be respectively connected to a pair of electrodes (91 and 92) of a high pressure discharge lamp (90). The power circuit (20, 30, 40, and 50) is configured to apply an AC voltage for keeping the high pressure discharge lamp (90) turned on across the pair of the output terminals (55 and 56). The starting circuit (60) is configured to apply a starting pulse voltage across the pair of the electrodes (91 and 92) of the high pressure discharge lamp (90). The starting circuit (60) is configured to have output characteristics of increasing the starting pulse voltage with an increase of a length of a pair of output wires (83) used with connection of the high pressure discharge lamp (90), and of decreasing the starting pulse voltage when the length of the pair of the output wires (83) exceeds a certain value.

### TECHNICAL FIELD

The present invention is directed to a high pressure discharge lamp lighting apparatus and a lighting fixture.

### BACKGROUND ART

In the past, there has been a lighting fixture configured to turn on a high pressure discharge lamp. The high pressure discharge lamp is also referred to as a HID (High Intensity Discharge) lamp.

The aforementioned lighting fixture includes a high pressure discharge lamp lighting apparatus, and a main fixture body configured to carry the high pressure discharge lamp lighting apparatus.

As disclosed in Japanese patent laid-open publication No. 63-150891, the high pressure discharge lamp lighting apparatus is configured to turn on a high pressure discharge lamp by use of an AC power received from an external AC source (e.g. commercial AC source).

The high pressure discharge lamp lighting apparatus includes a diode bridge, a boost chopper circuit, a step-down chopper circuit, a polarity reversion circuit, a starting circuit, and a control circuit, for example.

The diode bridge is configured to perform full-wave rectification on an AC voltage of the AC source.

The boost chopper circuit is configured to increase an output voltage of the diode bridge up to a predetermined value.

The step-down circuit is configured to decrease an output voltage of the boost chopper circuit down to a predetermined value.

The polarity reversion circuit is configured to convert an output voltage of the step-down chopper circuit into a square wave AC voltage of which polarity is reversed at a predetermined frequency, and apply the resultant square wave AC voltage across a pair of electrodes of the high pressure discharge lamp.

The control circuit is configured to control individually the boost chopper circuit, the step-down chopper circuit, and the polarity reversion circuit.

The starting circuit is configured to apply a starting pulse voltage across the pair of the electrodes of the high pressure discharge lamp to cause a dielectric breakdown of the high pressure discharge lamp in order to start the high pressure discharge lamp. The starting pulse voltage is a high pulse voltage having a relatively high voltage. For example, the starting circuit comprises a pulse transformer.

In the above lighting fixture, the high pressure discharge lamp is connected to the high pressure discharge lamp lighting apparatus by use of a pair of output wires, generally. For example, when the pair of the output wire has a length of a few meters, a stray capacitance generated across the output wires in the pair increases to a negligible extent. Especially, when two output wires are arranged in parallel with each other in a similar manner as seen in a VVF cable, the capacitance between the two output wires becomes considerably large. For example, with respect to a VVF cable, the capacitance per meter is 80 pF. Therefore, when the VVF cable has a length of 10 m, the capacitance is 800 pF.

The capacitance developed across the pair of the output wires affects on the pulse voltage applied across the pair of the electrodes of the high pressure discharge lamp. In other words, the starting pulse voltage has a lower voltage (peak voltage) as the output wire is extended (the capacitance developed across the pair of the output wires becomes larger).

In the conventional high pressure discharge lamp lighting apparatus, the starting pulse voltage monotonically lowers as the output wire extends (the capacitance between the output wires in the pair increases). Therefore, the length of the output wire is likely to cause a failure of starting the high pressure discharge lamp.

In order to avoid the failure of starting the high pressure discharge lamp, the starting pulse voltage may be selected to be sufficiently high for applying a proper voltage through the relatively long output wires. For example, the starting pulse voltage can increase by an increase of a turn ratio of the pulse transformer of the starting circuit.

However, when the output wire is relatively short, with an increase of the turn ratio of the pulse transformer of the starting circuit, the starting pulse voltage becomes excessively high. When the pulse voltage is varied corresponding to the length of the output wire, a timing at which the high pressure discharge lamp is turned on is also varied.

### DISCLOSURE OF INVENTION

In view of the above insufficiency, the present invention has been aimed to propose a high pressure discharge lamp lighting apparatus and a lighting fixture capable of reducing an influence of a pair of output wires used for connection of the high pressure discharge lamp.

The high pressure discharge lamp lighting apparatus in accordance with the present invention includes a power circuit and a starting circuit. The power circuit includes a pair of output terminals adapted to be respectively connected to a pair of electrodes of a high pressure discharge lamp. The power circuit is configured to apply an AC voltage for keeping the high pressure discharge lamp turned on across the pair of the output terminals. The starting circuit is configured to apply a starting pulse voltage across the pair of the electrodes of the high pressure discharge lamp. The starting circuit is configured to have output characteristics of increasing the starting pulse voltage with an increase of a length of a pair of output wires used with connection of the high pressure discharge lamp, and of decreasing the starting pulse voltage when the length of the pair of the output wires exceeds a certain value.

According to the present invention, in contrast to a situation where the starting pulse value voltage monotonically decreases as the length of the output wire increases in a similar manner as seen in the conventional art, it is possible to decrease a width of variation in the starting pulse voltage caused by varying the length of the output wire. Therefore, it is possible to reduce an influence caused by the output wires. Thus, the high pressure discharge lamp can be turned on even if the pair of the output wires is relatively long. Additionally, it is possible to prevent the starting pulse value from becoming excessively high even if the pair of the output wires is relatively short.

In a preferred embodiment, the starting circuit includes a pulse transformer. The starting circuit is configured to apply, across the pair of the electrodes of the high pressure discharge lamp, a secondary voltage of the pulse transformer as the starting pulse voltage. The secondary voltage is obtained when a primary voltage of the pulse transformer is equivalent to a predetermined value. The pulse transformer is configured to have a turn ratio and a coupling coefficient selected such that the starting circuit has the output characteristics.

In a more preferred embodiment, the high pressure discharge lamp lighting apparatus is configured to satisfy the following formula when N1 denotes the number of turns of a primary coil of the transformer, and N2 denotes the number of turns of a secondary coil of the transformer, and Vpm denotes a central value of a range of a specified value of the starting pulse voltage necessitated for starting the high pressure discharge lamp, and VN1 denotes the predetermined value.

$$\frac{N 2}{N 1} < \frac{Vpm}{V N 1} \qquad [ Formula 1 ]$$

In a furthermore preferred embodiment, the high pressure discharge lamp lighting apparatus is configured to satisfy the following formula when Cx denotes capacitance of a capacitive component considered to be connected in parallel with the primary coil of the pulse transformer, and LL denotes a leakage inductance of the pulse transformer, and T denotes a time necessitated for increasing the primary voltage from 0 to the predetermined value during a starting period of the high pressure discharge lamp.

$$T > \frac{1}{2} π \sqrt{LL \times Cx} \qquad [ Formula 2 ]$$

In a preferred embodiment, the starting circuit includes a pulse transformer, and a parallel capacitor connected across a primary coil of the pulse transformer. The starting circuit is configured to apply, across the pair of the electrodes of the high pressure discharge lamp, a secondary voltage of the pulse transformer as the starting pulse voltage. The secondary voltage is obtained when a primary voltage of the pulse transformer is equivalent to a predetermined value. The parallel capacitor is configured to have a capacitance selected such that the starting circuit has the output characteristics.

In a more preferred embodiment, the high pressure discharge lamp lighting apparatus is configured to satisfy the following formula when Cp denotes capacitance of the parallel capacitor, and Cx denotes capacitance of a virtual capacitor which is connected in series with the parallel capacitor and in parallel with the primary coil of the pulse transformer, and which is an equivalent circuit of a capacitive component across the pair of the output wires having the shortest length within a usable range, and LL denotes a leakage inductance of the pulse transformer, and T denotes a time necessitated for increasing the primary voltage from 0 to the predetermined value during a starting period of the high pressure discharge lamp.

$$T > \frac{1}{2} π \sqrt{LL \times ( \frac{Cx \times Cp}{Cx + Cp} )} \qquad [ Formula 3 ]$$

In a preferred embodiment, the starting circuit includes a pulse transformer. The starting circuit is configured to apply, across the pair of the electrodes of the high pressure discharge lamp, a secondary voltage of the pulse transformer as the starting pulse voltage. The secondary voltage is obtained when a primary voltage of the pulse transformer is equivalent to a predetermined value. The high pressure discharge lamp lighting apparatus includes a voltage increasing means. The voltage increasing means is configured to increase the primary voltage of the pulse transformer to adjust a time for increasing the primary voltage from 0 to the predetermined value such that the starting circuit has the output characteristics.

In a more preferred embodiment, the voltage increasing means includes a variable impedance circuit connected in series with a primary coil of the pulse transformer, and a control circuit configured to control the variable impedance circuit. The control circuit is configured to control the variable impedance circuit to adjust the time for increasing the primary voltage from 0 to the predetermined value such that the starting circuit has the output characteristics.

In a more preferred embodiment, the power circuit includes a DC power circuit configured to output a DC current, and an inverter circuit of a full-bridge type composed of electric field effect transistors. The inverter circuit is configured to convert the DC current obtained from the DC power circuit into a square wave AC current of which polarity is reversed at a predetermined frequency, and provide the resultant square wave AC current to the high pressure discharge lamp and a primary coil of the pulse transformer. The voltage increasing means includes a control circuit configured to control the electric field effect transistor of the inverter circuit. The control circuit is configured to gradually increase a voltage applied to a gate of the electric field effect transistor in order to adjust the time for increasing the primary voltage from 0 to the predetermined value such that the starting circuit has the output characteristics.

In a more preferred embodiment, the high pressure discharge lamp lighting apparatus is configured to satisfy the following formula when Cx denotes capacitance of a capacitive component considered to be connected in parallel with a primary coil of the pulse transformer, and LL denotes a leakage inductance of the pulse transformer, and T denotes a time necessitated for increasing the primary voltage from 0 to the predetermined value during a starting period of the high pressure discharge lamp.

$$T > \frac{1}{2} π \sqrt{LL \times Cx} \qquad [ Formula 4 ]$$

In a preferred embodiment, the starting circuit is configured to, while the pair of the output wires has a length within a usable range, output the starting pulse voltage exceeding a starting voltage of the high pressure discharge lamp.

In a more preferred embodiment, the starting circuit is designed such that a difference between the starting pulse voltage output when the pair of the output wires has the shortest length within the usable range and the starting pulse voltage output when the pair of the output wires has the longest length within the usable range does not exceed 500V.

With this arrangement, in contrast to a situation where the difference between the starting pulse voltage obtained when the length of the pair of the output wires is the shortest value and the starting pulse voltage obtained when the length of the pair of the output wires is the longest value exceeds 500V, it is possible to decrease the variation range of the starting pulse voltage with relation to the length of the pair of the output wires within the usable range.

In a preferred embodiment, the starting circuit is designed such that the certain value is not greater than the shortest length of the pair of the output wires within a usable range.

With this arrangement, the starting pulse voltage successfully has the maximum value when the length of the pair of the output wires is the shortest value within the usable range. In addition, the starting pulse voltage successfully has the minimum value when the length of the pair of the output wires is the longest value within the usable range. Therefore, in contrast to a situation where the certain value falls within the usable range, it is easy to obtain both the minimum value and the maximum value of the starting pulse voltage.

The lighting fixture in accordance with the present invention includes a high pressure discharge lighting apparatus and a main fixture body configured to carry the high pressure discharge lamp lighting apparatus. The high pressure discharge lamp lighting apparatus in accordance with the present invention includes a power circuit and a starting circuit. The power circuit includes a pair of output terminals adapted to be respectively connected to a pair of electrodes of a high pressure discharge lamp. The power circuit is configured to apply an AC voltage for keeping the high pressure discharge lamp turned on across the pair of the output terminals. The starting circuit is configured to apply a starting pulse voltage across the pair of the electrodes of the high pressure discharge lamp. The starting circuit is configured to have output characteristics of increasing the starting pulse voltage with an increase of a length of output wires used for connection of the high pressure discharge lamp, and of decreasing the starting pulse voltage when the length of the pair of the output wires exceeds a certain value.

According to the present invention, in contrast to a situation where the starting pulse voltage monotonically decreases as the length of the output wire increases in a similar manner as seen in the conventional art, it is possible to decrease a width of variation in the starting pulse voltage caused by varying the length of the output wire. Therefore, it is possible to reduce an influence caused by the output wires. Thus, the high pressure discharge lamp can be turned on even if the pair of the output wires is relatively long. Additionally, it is possible to prevent the starting pulse value from becoming excessively high even if the pair of the output wires is relatively short.

### BRIEF DESCRIPTION OF DRAWINGS

FIG. 1 is a circuit block diagram illustrating a high pressure discharge lamp lighting apparatus of a first embodiment,

FIG. 2 is a schematic view illustrating a lighting fixture including the above high pressure discharge lamp lighting apparatus,

FIG. 3 is an explanatory view illustrating operation of the above high pressure discharge lamp lighting apparatus,

FIG. 4 is a graph illustrating a relation between a length of output wires and a starting pulse voltage,

FIG. 5 is a graph illustrating a relation between the length of output wires and the starting pulse voltage,

FIG. 6 is a graph illustrating a relation between the length of output wires and the starting pulse voltage,

FIG. 7 is a graph illustrating a relation between the length of output wires and the starting pulse voltage,

FIG. 8 is a graph illustrating a relation between the length of output wires and the starting pulse voltage,

FIG. 9 is an explanatory view illustrating operation of the high pressure discharge lamp lighting apparatus of the first embodiment,

FIG. 10 is a graph illustrating a relation between the length of output wires and the starting pulse voltage,

FIG. 11 is a graph illustrating a relation between the length of output wires and a fundamental oscillation voltage,

FIG. 12 is a graph illustrating a relation between the length of output wires and a parasitic oscillation voltage,

FIG. 13 is a circuit block diagram illustrating a high pressure discharge lamp lighting apparatus of a third embodiment,

FIG. 14 is an explanatory view illustrating operation of the above high pressure discharge lamp lighting apparatus,

FIG. 15 is a graph illustrating a relation between the length of output wires and the starting pulse voltage with relation to the above high pressure discharge lamp lighting apparatus,

FIG. 16 is a circuit block diagram illustrating a primary part of a high pressure discharge lamp lighting apparatus of a fourth embodiment,

FIG. 17 is an explanatory view illustrating operation of the above high pressure discharge lamp lighting apparatus,

FIG. 18 is an explanatory view illustrating operation of the above high pressure discharge lamp lighting apparatus.

FIG. 19 is a graph illustrating a relation between a wiring capacitance and both the starting pulse voltage and a parasitic pulse voltage.

FIG. 20 is a graph illustrating a relation between the wiring capacitance and both the starting pulse voltage and the parasitic pulse voltage,

FIG. 21 is a graph illustrating a relation between the wiring capacitance and both the starting pulse voltage and the parasitic pulse voltage,

FIG. 22 is a graph illustrating a relation between the wiring capacitance and both the starting pulse voltage and the parasitic pulse voltage,

FIG. 23 is a graph illustrating a relation between the wiring capacitance and both the starting pulse voltage and the parasitic pulse voltage.

FIG. 24 is a graph illustrating a relation between the wiring capacitance and both the starting pulse voltage and the parasitic pulse voltage,

FIG. 25 is an explanation view illustrating operation of a polarity reversion drive unit of the above high pressure discharge lamp lighting apparatus,

FIG. 26 is a circuit block diagram illustrating a primary part of a modification of the above high pressure discharge lamp lighting apparatus,

FIG. 27 is an explanatory view illustrating operation of the modification of the above high pressure discharge lamp lighting apparatus,

FIG. 28 is a circuit block diagram illustrating a primary part of a high pressure discharge lamp lighting apparatus of a fifth embodiment, and

FIG. 29 is an explanatory view illustrating the above high pressure discharge lamp lighting apparatus.

### BEST MODE FOR CARRYING OUT THE INVENTION

### First Embodiment

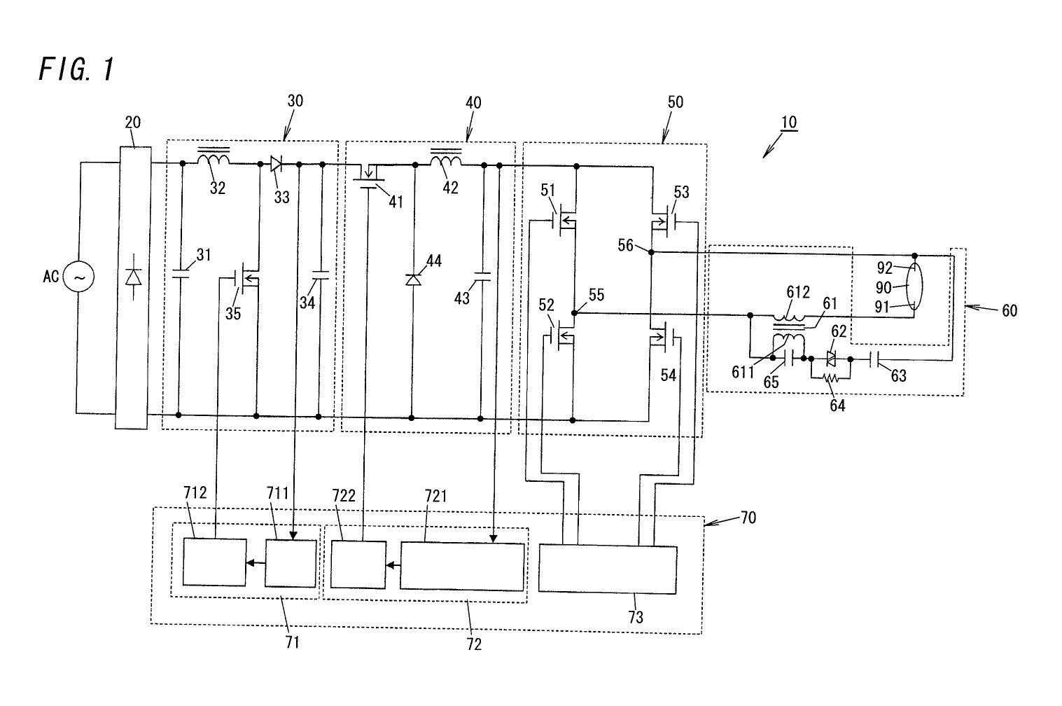

As shown in FIG. 1, the high pressure discharge lamp lighting apparatus 10 of the present embodiment is configured to turn on a high pressure discharge lamp 90 by use of a power obtained from an external AC source AC.

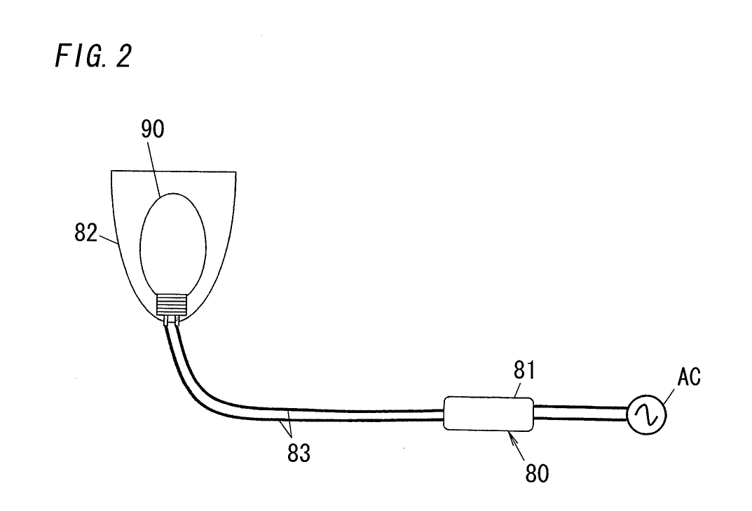

The high pressure discharge lamp lighting apparatus 10 is used in a lighting fixture 80 show in FIG. 2, for example. The lighting fixture 80 includes a main fixture body 81 configured to house and carry the high pressure discharge lamp lighting apparatus 10, and a light body 82 configured to carry the high pressure discharge lamp 90. The high pressure discharge lamp 10 is electrically connected to the high pressure discharge lamp 90 through a pair of output wires 83. For example, the output wire 83 is a VVF cable.

The high pressure discharge lamp lighting apparatus 10 includes a rectification circuit 20, a boost chopper circuit 30, a step-down chopper circuit 40, a polarity reversion circuit 50, a starting circuit 60, and a control circuit 70.

The rectification circuit 20 is configured to perform full-wave rectification on an AC voltage (input voltage) of the AC source AC. The rectification circuit 20 comprises a diode bridge, for example.

The boost chopper circuit 30 is configured to increase an output voltage of the rectification circuit 20 and output the resultant output voltage. The boost chopper circuit 30 is a well known circuit, and is also referred to as a boost converter. The boost chopper circuit 30 includes an input capacitor 31, an inductor 32, a diode 33, an output capacitor 34, and a switching element 35. The input capacitor 31 is connected across output terminals of the rectification circuit 20. The inductor 32 has its one end connected to the output terminal of a high voltage side of the rectification circuit 20. The diode 33 has its anode connected to the other end of the inductor 32. The output capacitor 34 has its one end connected to a cathode of the diode 33, and has its other end connected to the output terminal of a low voltage side of the rectification circuit 20. The switching element 35 has its one end connected to a junction of the inductor 32 and the diode 33, and has its other end connected to a junction of the rectification circuit 20 and the output capacitor 34. Both ends of the output capacitor 34 define output terminals of the boost chopper circuit 30, respectively.

The step-down chopper circuit 40 is configured to decrease an output voltage of the boost chopper circuit 30 and output the resultant output voltage. The step-down chopper circuit 40 is a well known circuit, and is also referred to as a back converter. The step-down chopper circuit 40 includes a switching element 41, an inductor 42, an output capacitor 43, and a diode 44. The switching element 41, the inductor 42, and the output capacitor 43 constitute a series circuit. The series circuit is connected across the output terminals of the boost chopper circuit 30. The diode 44 has its anode connected to a junction of the output capacitor 43 and the output terminal of a low voltage side of the boost chopper circuit 30. The diode 44 has its cathode connected to a junction of the switching element 41 and the inductor 42. Both ends of the output capacitor 43 define output terminals of the step-down chopper circuit 30, respectively.

The polarity reversion circuit 50 is configured to convert the output voltage of the step-down chopper circuit 40 into an AC voltage (square wave AC voltage of which polarity is reversed at a predetermined frequency). The polarity reversion circuit 50 includes four switching elements 51 to 54. The switching elements 51 and 52 and the switching elements 53 and 54 constitute series circuits, respectively. These two series circuits are connected in parallel with each other. The two series circuits connected in parallel with each other are connected across the output terminals of the step-down chopper circuit 40. In the polarity reversion circuit 50, a junction of the switching elements 51 and 52 is defined as one output end (first output end) 55, and a junction of the switching elements 53 and 54 is defined as another output end (second output end) 56. The switching elements 51 to 54 are electric field effect transistors. In other words, the polarity reversion circuit 50 comprises an inverter circuit of a full-bridge type composed of electric field effect transistors.

The rectification circuit 20, the boost chopper circuit 30, and the step-down chopper circuit 40 constitute a DC power circuit configured to output a DC current.

In addition, the polarity reversion circuit 50 is configured to convert the DC current obtained from the DC power circuit into a square wave AC current of which polarity is reversed at the predetermined frequency, and provide the resultant square wave AC current to the high pressure discharge lamp 90 and a primary coil 611 of a pulse transformer 61 of the starting circuit 60.

Consequently, with respect to the high pressure discharge lamp lighting apparatus 10, the DC power circuit and the polarity reversion circuit 50 constitute a power circuit for keeping the high pressure discharge lamp 90 turned on.

The control circuit 70 is configured to control individually the boost chopper circuit 30, the step-down chopper circuit 40, and the polarity reversion circuit 50. The control circuit 70 includes a boost control unit 71, a step-down control unit 72, and a polarity reversion drive unit 73.

The boost control unit 71 includes a boost detection unit 711 configured to measure the output voltage of the boost chopper circuit 30, and a boost drive unit 712 configured to turn on and off the switching element 35. The boost drive unit 712 turns on and off the switching element 35 according to a duty ratio which is selected such that the output voltage measured by the boost detection unit 711 is equivalent to a predetermined target value.

The step-down control unit 72 includes a step-down detection unit 721 configured to measure the output voltage of the step-down chopper circuit 40, and a step-down drive unit 722 configured to turn on and off the switching element 41. The step-down drive unit 722 turns on and off the switching element 41 in accordance with a duty ratio corresponding to the output voltage measured by the step-down detection unit 721. Additionally, the step-down drive unit 722 is configured to judge, on the basis of the output voltage measured by the step-down detection unit 721, whether or not the high pressure discharge lamp 90 is kept turned on. Upon determining that the high pressure discharge lamp 90 is not kept turned on, the step-down drive unit 722 increases the output voltage of the step-down chopper 40 to a level higher than the output voltage output that is given when the step-down drive unit 722 determines that the high pressure discharge lamp 90 is kept turned on.

The polarity reversion drive unit 73 is configured to output drive signals to the switching elements 51 to 54, respectively. Upon receiving the drive signal having a high level, the switching element turns on. Upon receiving the drive signal having a low level, the switching element turns off. The polarity reversion drive unit 73 outputs the drive signal to each of the switching elements 51 to 54 so as to simultaneously or synchronously turn on and off the switching elements 51 to 54 arranged diagonally with each other, and to alternately turn on and off the switching elements 51 to 54 connected in series with each other. In other words, the polarity reversion drive unit 73 selects alternately a condition where the switching elements 51 and 54 are kept turned on and the switching elements 52 and 53 are kept turned off and a condition where the switching elements 52 and 53 are kept turned on and the switching elements 51 and 54 are kept turned off.

Since the control circuit 70 can be realized by means of conventional techniques, no detailed explanation and drawing thereof are deemed necessary.

The starting circuit 60 is configured to provide a starting pulse voltage (hereinafter referred to as “starting pulse”) to the high pressure discharge lamp 90. In the high pressure discharge lamp 10, a second end of a secondary coil 612 and the second output end 56 of the polarity reversion circuit 50 are connected to one electrode (first electrode) 91 and another electrode (second electrode) 92 of the high pressure discharge lamp 90 by use of the output wires 83, respectively. Therefore, the starting circuit 60 is interposed between the polarity reversion circuit 50 and the high pressure discharge lamp 90. The starting circuit 60 includes the aforementioned pulse transformer 61 acting as a boost transformer, a switching element 62, a series capacitor 63, a resistor 64, and a parallel capacitor 65.

The secondary coil 612 of the pulse transformer 61 has its first end connected to the first output end 55 of the polarity reversion circuit 50. The primary coil 611 of the pulse transformer 61 has its first end connected to the first end of the secondary coil 612. The primary coil 611 has its second end connected to the second output end 56 of the polarity reversion circuit 50 via the series circuit 63 and a parallel circuit of the switching element 62 and the resistor 64. The switching element 62 is a two-terminal bi-directional thyristor. Therefore, when a voltage V62 across the switching element 62 exceeds a break-over voltage (on voltage), the switching element 62 is turned on.

The series capacitor 63, the switching element 62, and the resistor 64 constitute a voltage generation unit configured to apply a voltage (primary voltage) V611 across the primary coil 611 of the pulse transformer 61 during a starting period of the high pressure discharge lamp 90. The starting circuit 60 is configured to apply, across the pair of the electrodes 91 and 92 of the high pressure discharge lamp 90, a secondary voltage V612 as the starting pulse voltage. With this situation, the secondary voltage V612 is obtained when the primary voltage V611 of the pulse transformer 61 is equivalent to a predetermined value (peak voltage of the primary voltage V611) VN1.

The parallel capacitor 65 is connected in parallel with the primary coil 611 of the pulse transformer 61. Besides, the parallel capacitor 65 has a capacitance C65 greater than both a stray capacitance C611 of the primary coil 611 and a stray capacitance C612 of the secondary coil 612 of the pulse transformer 61.

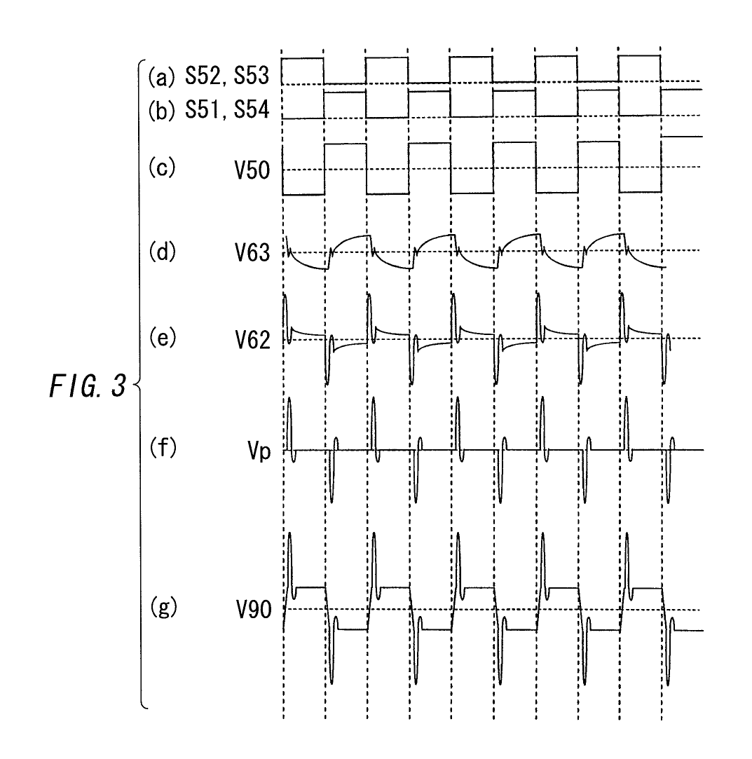

Besides, the parallel capacitance 65 is provided in order to improve a starting performance of the high pressure discharge lamp 90. With reference to FIG. 3, an explanation is made to operation of the high pressure discharge lamp lighting apparatus 10 without the parallel capacitor 65. In FIG. 3, (a) shows the drive signals S52 and S53 respectively output to the switching elements 52 and 53. In FIG. 3, (b) shows the drive signals S51 and S54 respectively output to the switching elements 51 and 54. In FIG. 3, (c) shows an output voltage V50 of the polarity reversion circuit 50. In FIG. 3, (d) shows a voltage (charging voltage) V63 developed across the series capacitor 63. In FIG. 3, (e) shows the voltage V62 applied across the switching element 62. In FIG. 3, (f) shows a value (hereinafter referred to as “starting pulse value”) Vp of the starting pulse. In FIG. 3, (g) shows a voltage (hereinafter referred to as “lamp voltage”) V90 applied across the pair of the electrodes 91 and 92 of the high pressure discharge lamp 90. In FIG. 3, lateral axes of respective (a) to (g) represent time.

In the starting period, the series capacitor 63 is charged by a current which flows through the resistor 64 and the primary coil 611 of the pulse transformer 61. In this situation, the voltage V62 is kept not greater than the break-over voltage of the switching element 62. Therefore, the switching element 62 is kept turned off. Meanwhile, when the polarity is reversed in the polarity reversion circuit 50, a voltage, which is a sum of the output voltage V50 of the polarity reversion circuit 50 and the charging voltage V63 of the series capacitor 63, is applied across the switching element 62. Therefore, the switching element 62 is turned on, and then the primary coil 611 of the pulse transformer 61 receives a voltage. Thereby, the secondary voltage V612 is induced across the secondary coil 612 of the pulse transformer 61. As a result, the starting pulse is applied across the pair of the electrodes 91 and 92 of the high pressure discharge lamp 90, and then the high pressure discharge lamp 90 starts to operate (starts to emit light).

A frequency f1 of a main component of the starting pulse is a resonant frequency of a resonant circuit constituted by the series capacitor 63, the primary coil 611, and the output capacitor 43. Frequency f1 is represented by the following formula (1), wherein L611 denotes an inductance of the primary coil 611, and C63 denotes a capacitance of the series capacitor 63, and C43 denotes a capacitance of the output capacitor 43.

$$\begin{matrix}[ Formula 5 ] & \\ f 1 = \frac{1}{2 π \sqrt{L 611 \times ( \frac{C 43 \times C 63}{C 43 + C 63} )}} & ( 1 )\end{matrix}$$

The lamp voltage V90 includes a component having a high frequency relative to the frequency f1. When the lamp voltage V90 sees a high frequency, there arises a shortage of a period in which a sufficiently high voltage is applied across the pair of the electrodes 91 and 92 of the high pressure discharge lamp 90 for starting the same. In this situation, the starting trouble of the high pressure discharge lamp 90 is likely to occur. The above high frequency may occur due to the stray capacitances C611 and C612 respectively corresponding to the coils 611 and 612 of the pulse transformer 61. Thus, the starting circuit 60 is provided with the parallel capacitor 65 in order to reduce the component of the high frequency and improve the starting performance of the high pressure discharge lamp 90.

The feature of the high pressure discharge lamp lighting apparatus 10 resides in that the starting circuit 60 has output characteristics (hereinafter referred to as “mountain-shaped output characteristics”) having a mountain shape of increasing the starting pulse value Vp (raising the starting pulse) with an increase of the length L of output wires 83 (hereinafter referred to as “output wire length”), and of decreasing the starting pulse value Vp (lowering the starting pulse) when the output wire length L exceeds a certain value. In other words, given the starting pulse value Vp as a function of the output wire length L, the function has a local maximum point. At the local maximum point, the output wire length L is equivalent to the certain value and the starting pulse value Vp is equivalent to the local maximum value (peak value).

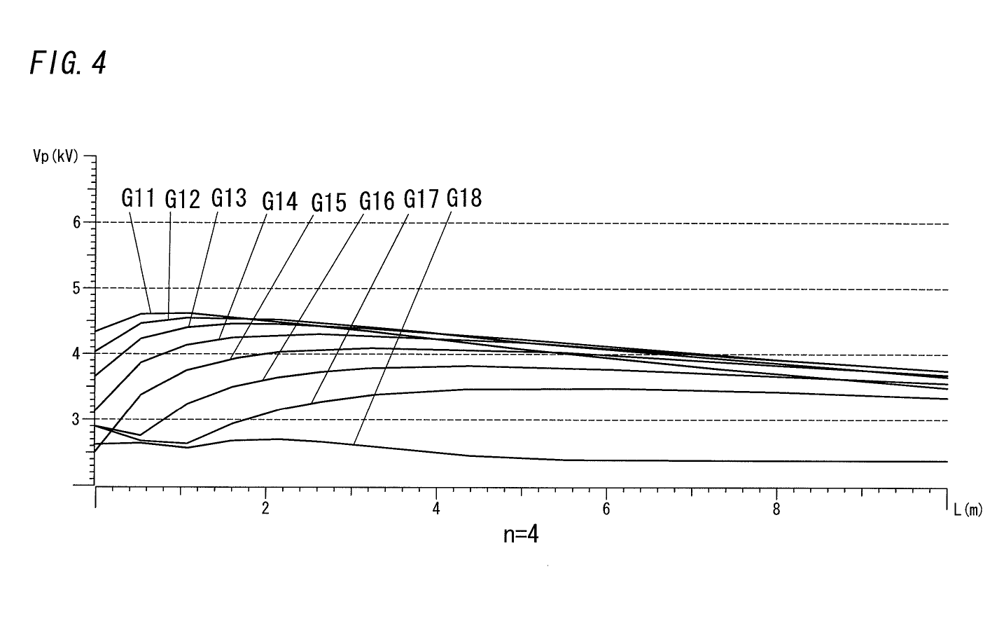

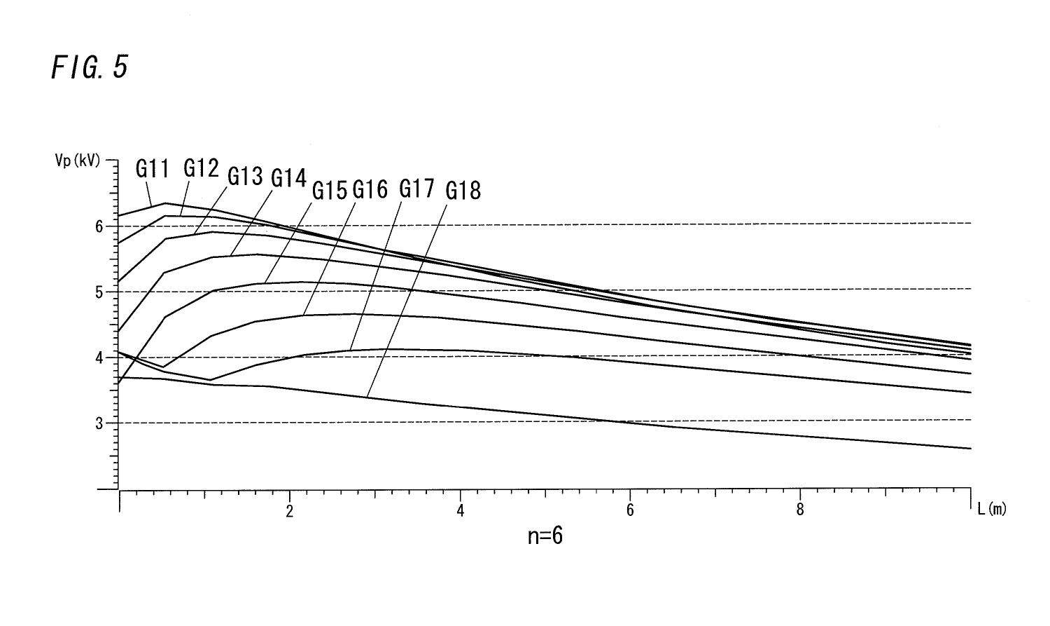

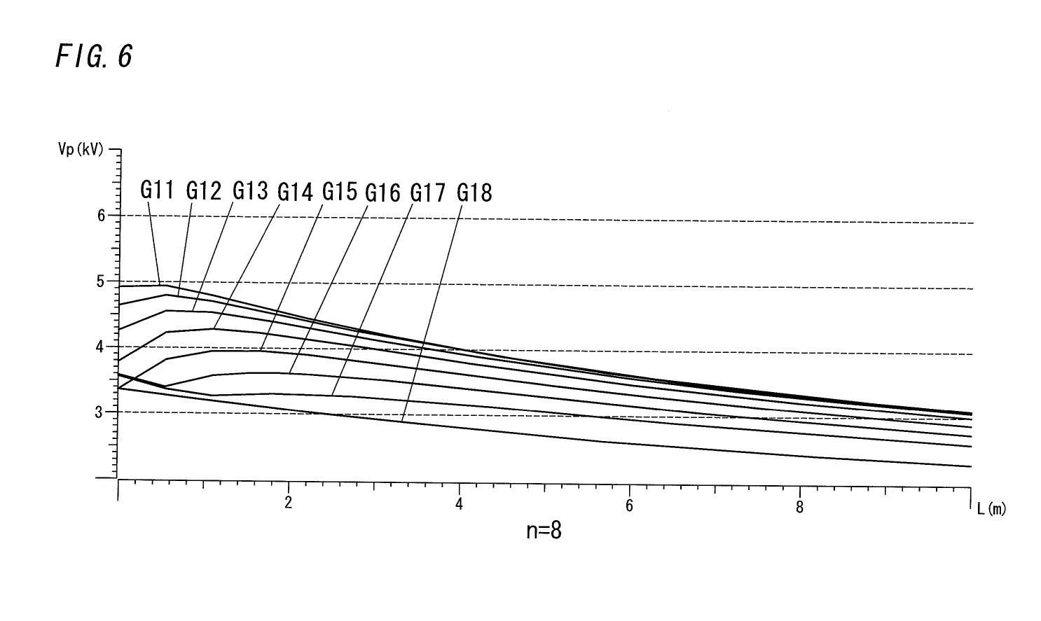

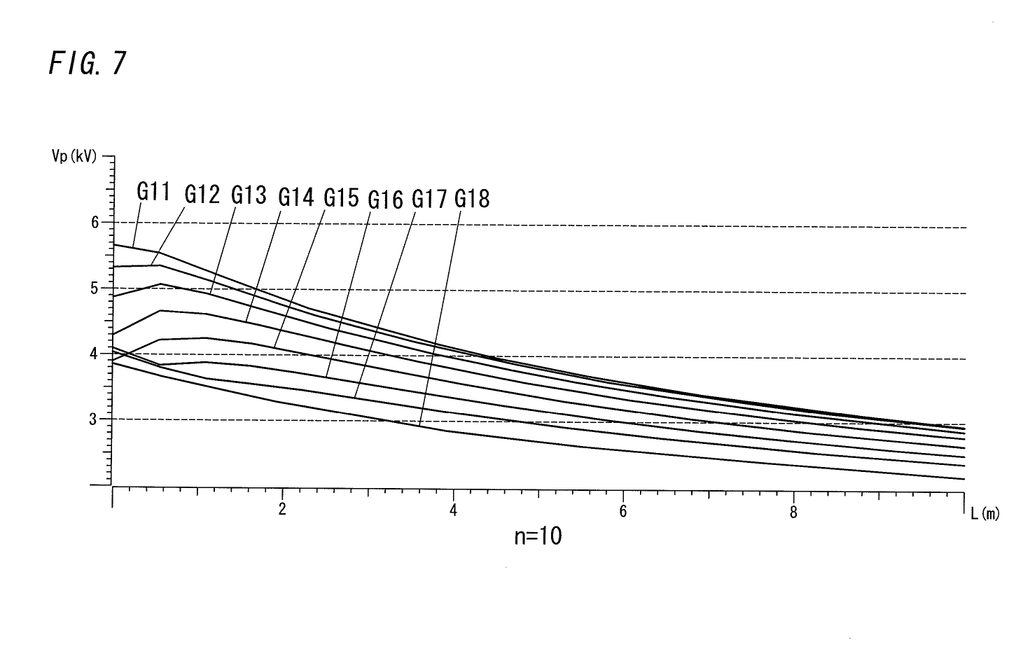

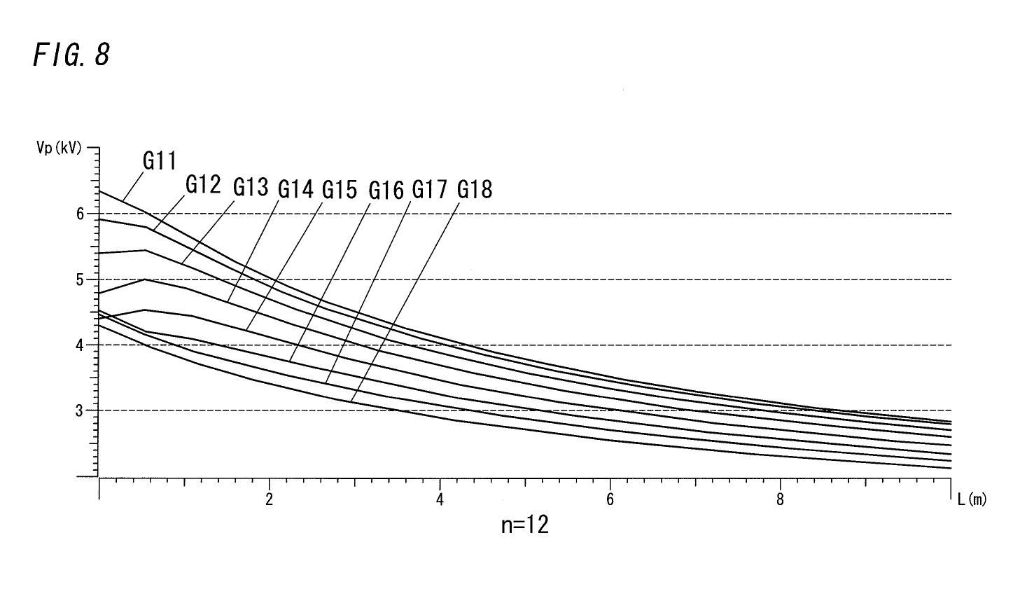

FIGS. 4 to 8 show graphs illustrating relations between the starting pulse value Vp and the output wire length L, respectively. In respective FIGS. 4 to 8, a lateral axis denotes the output wire length L [m], and a vertical axis denotes the starting pulse value Vp [kV]. FIG. 4 shows a variation of the output characteristics of the starting circuit 60 observed when varying a coupling coefficient k of the pulse transformer 61 with the turn ratio n of 4. Likewise, FIG. 5 shows the variation observed when varying the coupling coefficient k of the pulse transformer 61 with the turn ratio n of 6, and FIG. 6 shows the variation observed when varying the coupling coefficient k of the pulse transformer 61 with the turn ratio n of 8, and FIG. 7 shows the variation observed when varying the coupling coefficient k of the pulse transformer 61 with the turn ratio n of 10, and FIG. 8 shows the variation observed when varying the coupling coefficient k of the pulse transformer 61 with the turn ratio n of 12. Additionally, in respective FIGS. 4 to 8, graphs G11, G12, G13, G14, G15, G16, G17, and G18 indicate the output characteristics with the coupling coefficients k of 0.800, 0.880, 0.928, 0.956, 0.974, 0.984, 0.990, and 0.998, respectively. Concerning instances respectively shown in FIGS. 4 to 8, the primary voltage V611 of the pulse transformer 61 has the peak value VN1 of about 600V.

In addition, the starting pulse value Vp can be considered as a sum of a fundamental oscillation voltage Vpa and a parasitic oscillation voltage Vpb (that is, Vp=Vpa+Vpb).

The fundamental oscillation voltage Vpa is a component caused by a resonant circuit constituted by the output capacitor 43, the primary coil 611, the series capacitor 63, the parallel capacitor 65, and a capacitance (hereinafter referred to as “wiring capacitance”) C83 of a stray-capacitor which is developed across the pair of the output wires 83.

The parasitic oscillation voltage Vpb is a component caused by a resonant circuit which a capacitive component (hereinafter referred to as “parallel capacitive component”) considered to be connected in parallel with the primary coil 611 and a leak inductance of the pulse transformer 61 constitute.

In respective FIGS. 4 to 8, the parasitic oscillation voltage Vpb is hardly seen in the starting pulse value indicated by the graph G18. That is, the graph G18 indicates the fundamental oscillation voltage Vpa. Therefore, differences between each starting pulse value Vp indicated by the graphs G11 to G17 and the starting pulse value Vp indicated by the graph G18 indicate the parasitic oscillation voltages Vpb.

For example, in the graph G14 with the turn ratio n of 4, the starting pulse value Vp is about 3100V when the output wire length L is Urn. This starting pulse value Vp is considered to as the sum of the fundamental oscillation voltage Vpa of about 2600V and the parasitic oscillation voltage Vpb of about 500V. By contrast, a product of the peak value VN1 (=600V) and the turn ratio n (=4) is 2400V. In other words, the starting pulse value Vp exceeds the product of the peak value VN1 and the turn ratio n.

Consequently, in view of the available high pressure discharge lamp 90 having a standard range of the starting pulse Vp, the starting circuit 60 is designed to have the turn ratio n smaller than a central value Vpm (e.g. Vpm=4.5 kV, when the range of the specified value is from 4.0 kV to 5.0 kV) divided by the peak value VN1 (=Vpm/VN1). That is, the starting circuit 60 satisfies the following formula (2) wherein N1 denotes the number of turns of the primary coil 611 and N2 denotes the number of turns of the secondary coil 612.

$$\begin{matrix}[ Formula 6 ] & \\ \frac{N 2}{N 1} < \frac{Vpm}{V N 1} & ( 2 )\end{matrix}$$

As apparent form FIGS. 4 to 8, the turn ratio n (=N2/N1) and the coupling coefficient k of the pulse transformer 61 changes the output characteristics of the starting circuit 60.

In view of the above, in the high pressure discharge lamp lighting apparatus 10, the turn ratio n and the coupling coefficient k are selected such that the starting circuit 60 has the above mountain-shaped output characteristics (the output characteristics of the starting circuit 60 become the above mountain-shaped output characteristics).

According to the aforementioned high pressure discharge lamp lighting apparatus of the present embodiment, in contrast to a situation where the starting pulse value Vp monotonically decreases as the length of the output wire 83 increases in a similar manner as seen in the conventional art, it is possible to decrease a width of variation in the starting pulse value Vp caused by varying the length of the output wire 83. Therefore, it is possible to reduce an influence caused by the pair of the output wires 83. Thus, the high pressure discharge lamp 90 can be turned on even if the pair of the output wires 83 is relatively long. Additionally, it is possible to prevent the starting pulse value Vp from becoming excessively high even if the pair of the output wires 83 is relatively short.

Especially, the high pressure discharge lamp lighting apparatus 10 utilizes the pulse transformer 61 to give the above mountain-shaped characteristics to the starting circuit 60. Therefore, according to the high pressure discharge lamp lighting apparatus 10, it is unnecessary to newly add circuits used for giving the above mountain-shaped characteristics to the starting circuit 60.

It is noted here that the wiring capacitance C83 gives rise to a certain influence on the parallel capacitive component (that is, an influence on the starting pulse value Vp) in much the same as is given by a capacitance of a capacitor (hereinafter referred to as “virtual capacitor”) connected in series with the parallel capacitor 65 and in parallel with the primary coil 611. The virtual capacitor has a capacitance of n²*C83. Therefore, an increase of the turn ratio n exaggerates the decrease in the width of the starting pulse value Vp caused when the pair of the output wires 83 becomes long.

A primary factor of developing the parallel capacitive component includes the stray capacitance developed between the output wires 83 in the pair and the parallel capacitor 65. Besides, the other factor includes the parasitic capacitances C611 and C612 respectively corresponding to the coils 611 and 612 of the pulse transformer 61, and gives less influence relative to the stray capacitance developed between the output wires 83 in the pair and the parallel capacitor 65.

When the wiring capacitance C83 is assumed to be equivalent to the capacitance of the virtual capacitor, the capacitance of the parallel capacitive component is considered as a capacitance of a series circuit of the virtual capacitor and the parallel capacitor 65. A frequency (hereinafter referred to as “fundamental oscillation frequency”) fa of the fundamental oscillation voltage Vpa is expressed by the following formula (3). Further, a frequency (hereinafter referred to as “parasitic oscillation frequency”) fb of the parasitic oscillation voltage Vpb is expressed by the following formula (4), wherein LL denotes the leak inductance (that is, an inductance component of the leak impedance) of the pulse transformer 61.

$$\begin{matrix}[ Formula 7 ] & \\ fa \approx \frac{1}{2 π \sqrt{L 6 \; 11 \times ( \frac{C 43 \times C 63}{C 43 + C 63} + C 65 + {n}^{2} \times C 83 )}} & ( 3 ) \\ fb \approx \frac{1}{2 π \sqrt{LL \times ( \frac{{n}^{2} \times C 83 \times C 65}{{n}^{2} \times C 83 + C 65} )}} & ( 4 )\end{matrix}$$

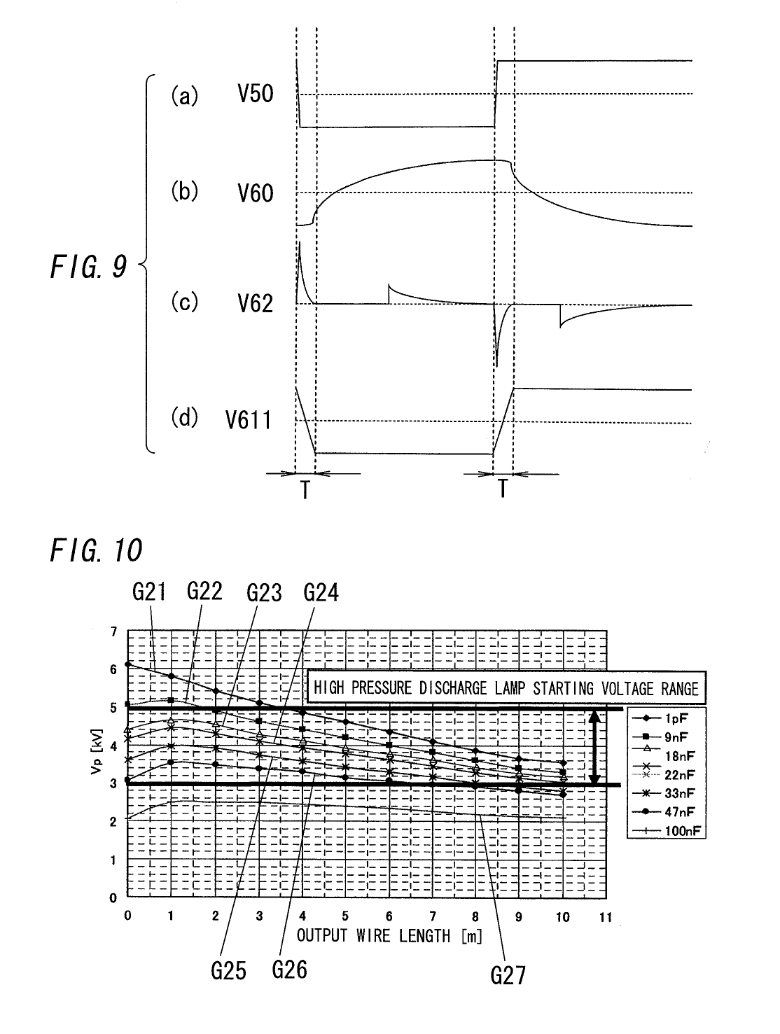

As shown in FIG. 9, it takes a time T (see FIG. 9, hereinafter referred to as “primary voltage rising time”) to increase the primary voltage V611 from 0 to the peak value VN1 or to decrease the primary voltage V611 from the peak value VN1 to 0. The primary voltage rising time T is constant irrespective of the coupling coefficient k. Besides, in FIG. 9, (a) shows a time variation of the output voltage V50 of the polarity reversion circuit 50. In FIG. 9, (b) shows a time variation of the charging voltage V63 of the series capacitor 63. In FIG. 9, (c) shows a time variation of the voltage V62 across the switching element 62. In FIG. 9, (d) shows a time variation of the primary voltage V611.

The parasitic oscillation voltage Vpb has a local maximum point defined as a point in which the primary voltage rising time (primary voltage variation time) T and the parasitic oscillation frequency fb are satisfy a relation of T=¼fb. A value of ¼fb monotonically increases with an increase of the wiring capacitance C83 (that is, the output wire length L). Therefore, in order that the parasitic oscillation voltage Vpb has the local maximum point within a range (hereinafter referred to as “usable range”) of the supposed output wire length L, the relation of T>¼fb1 need be satisfied. Besides, fb1 denotes a parasitic oscillation frequency obtained when the output wire length L is the shortest within the usable range. The usable range is defined as a range of the length of the pair of the output wires 83 assumed to be actually used for connecting of the high pressure discharge lamp lighting apparatus 10 and the high pressure discharge lamp 90.

In order to satisfy the relation of T>¼fb1, it is sufficient that the leak inductance LL is adjusted by adjusting the coupling coefficient k by use of conventional techniques. When the parallel capacitive component obtained when the output wire length L is the shortest within the usable range is Cx, the relation of T>¼fb1 is represented as the following formula (5).

$$\begin{matrix}[ Formula 8 ] & \\ T > \frac{1}{2} π \sqrt{LL \times Cx} & ( 5 )\end{matrix}$$

The starting pulse value Vp has a local maximum point within the usable range in a relationship with the output wire length L when an increase amount exceeds a decrease amount. The above increase amount is defined as a difference between the local maximum value of the parasitic oscillation voltage Vpb and the parasitic oscillation voltage Vpb obtained when the output wire length L is 0. The above decrease amount is defined as a difference between the fundamental oscillation voltage Vpa obtained when the output wire length L is 0 and the fundamental oscillation voltage Vpa obtained when the output wire length L has a value such that the parasitic oscillation voltage Vpb becomes the local maximum value. In order that the above increase amount exceeds the above decrease amount, it is sufficient that the turn ratio n and the coupling coefficient k are appropriately selected as mentioned in the above.

Also as apparent from FIGS. 4 to 8, the leak inductance LL decrease as the coupling coefficient k increases. Therefore, the local maximum point (the local maximum value of the starting pulse value Vp) moves right (moves toward a side in which the output wire length L becomes longer). Accordingly, it is possible to restrain an increase of the starting pulse value Vp caused by an increase of the output wire length L. Thus, the coupling coefficient is preferred to be increased when there is a possibility of an increase of the output wire length L.

Besides, the starting circuit 60 is configured to, while the output wire length L falls within the usable range, select the starting pulse value Vp exceeding a starting voltage of the high pressure discharge lamp 90. For example, it is assumed that the starting pulse value Vp necessitated for initiating the high pressure discharge lamp 90 falls within a range of 3.5 kV to 5 kV and the output wire length L falls within a range of 0 m to 10 m. In this situation, when the turn ratio n is 6 and the coupling coefficient k falls within a range of 0.980 to 0.990, the starting pulse value Vp is kept greater than the starting voltage within the usable range.

Additionally, the starting circuit 60 is preferred to be designed such that the certain value is not greater than the shortest output wire length L within the usable range. That is, when the shortest value of the output wire length L within the usable range is kept greater than the output wire length L at the local maximum point of the starting pulse value Vp (in other words, a specification or the like prohibits use of the pair of the output wires 83 shorter than the output wire length L at the local maximum point), the starting pulse value Vp monotonically decreases with an increase of the output wire length L within the usable range. When the output wire length L giving the local maximum point of the starting pulse voltage Vp falls within the usable range, it is necessary to check whether the starting pulse value Vp has the minimum value at either the longest value or the shortest value of the output wire length L within the usable range. In a situation where the shortest value of the output wire length L within the usable range is kept longer than the output wire length L at the local maximum point of the starting pulse value Vp, the starting pulse value Vp successfully has the maximum value when the output wire length L is the shortest value. In addition, the starting pulse value Vp successfully has the minimum value when the output wire length L is the longest value. Therefore, it is easy to obtain both the minimum value and the maximum value of the starting pulse value Vp.

Moreover, the starting pulse value Vp at the shortest value of the output wire length L within the usable range is preferred to be identical to the starting pulse value Vp at the longest value of the output wire length L within the usable range. With this arrangement, in contrast to a situation where the starting pulse value Vp at the shortest value of the output wire length L within the usable range is different from the starting pulse value Vp at the longest value of the output wire length L within the usable range, it is possible to decrease a width of variation in the starting pulse value Vp with relation to the output wire length L within the usable range. Therefore, it is possible to reduce a fluctuation of timing of lighting the high pressure discharge lamp 90. For example, as indicated by the graph G13 in FIG. 4, when the turn ratio n is 4 and the coupling coefficient k is 0.928, the starting pulse value Vp at the shortest value of the output wire length L within the usable range is approximately equal to the starting pulse value Vp at the longest value of the output wire length L within the usable range.

Actually, the high pressure discharge lamp 90 and the respective circuit parts have inherent fluctuations with respect to certain characteristics. Therefore, it is difficult to strictly adjust the starting pulse value Vp at the shortest value of the output wire length L within the usable range to the starting pulse value Vp at the longest value of the output wire length L within the usable range.

Accordingly, when it is impossible to adjust the starting pulse value Vp at the shortest value of the output wire length L within the usable range to the starting pulse value Vp at the longest value of the output wire length L within the usable range, a difference between the maximum value and the minimum value of the starting pulse value Vp is preferred to be kept not exceeding 500V. In other words, the starting circuit 60 is preferred to be designed such that the difference between the starting pulse value Vp obtained when the output wire length L is the shortest value within the usable range and the starting pulse value Vp obtained when the output wire length L is the longest value within the usable range does not exceed 500V.

With this arrangement, in contrast to a situation where the difference between the starting pulse value Vp obtained when the length of the output wire 83 is the shortest value within the usable range and the starting pulse value Vp obtained when the length of the output wire 83 is the longest value within the usable range exceeds 500V, it is possible to decrease a width of variation in the starting pulse value Vp with relation to the length of the output wire 83 within the usable range.

### Second Embodiment

The high pressure discharge lamp lighting apparatus 10 has a circuit configuration similar to that of the first embodiment. Therefore, FIGS. 1 and 9 are cited for an explanation of the high pressure discharge lamp lighting apparatus 10 of the present embodiment.

FIG. 10 shows a graph illustrating a relation between the starting pulse value Vp and the output wire length L. In FIG. 10, a lateral axis denotes the output wire length L [m], and a vertical axis denotes the starting pulse value Vp [kV]. In FIG. 10, graphs G21 to G27 indicate the output characteristics with the capacitances C65 of the parallel capacitor 65 of 1 pF, 9 nF, 18 nF, 22 nF, 33 nF, 47 nF, and 100 nF, respectively. That is, FIG. 10 shows a variation of the output characteristics of the starting circuit 60 observed when varying the capacitance C65 of the parallel capacitor 65.

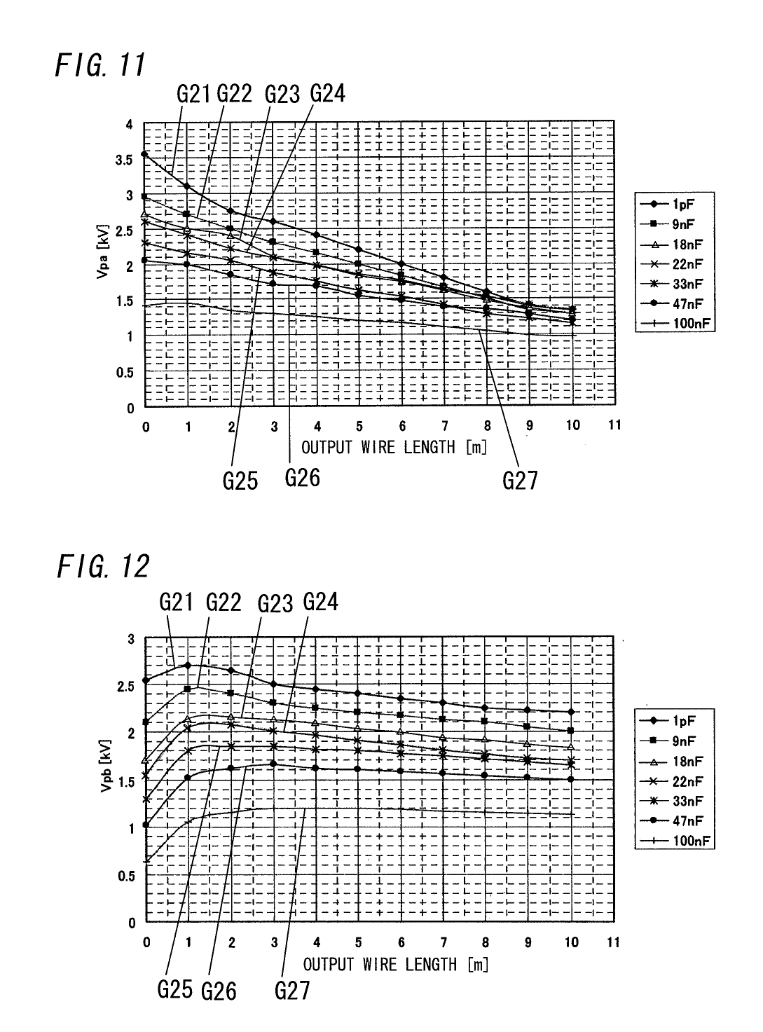

FIG. 11 shows a graph illustrating a relation between the fundamental oscillation voltage Vpa and the output wire length L. In FIG. 11, a lateral axis denotes the output wire length L [m], and a vertical axis denotes the fundamental oscillation voltage Vpa [kV].

FIG. 12 shows a graph illustrating a relation between the parasitic oscillation voltage Vpb and the output wire length L. In FIG. 12, a lateral axis denotes the output wire length L [m], and a vertical axis denotes the parasitic oscillation voltage Vpb [kV].

Also in FIGS. 11 and 12, in a similar fashion as FIG. 10, graphs G21 to G27 indicate the output characteristics with the capacitances C65 of the parallel capacitor 65 of 1 pF, 9 nF, 18 nF, 22 nF, 33 nF, 47 nF, and 100 nF, respectively.

As apparent from the graphs shown in FIG. 10, the capacitance C65 of the parallel capacitor 65 changes the output characteristics of the starting circuit 60.

In view of this point, with respect to the high pressure discharge lamp lighting apparatus 10, instead of the turn ratio n and the coupling coefficient k of the pulse transformer 61, the capacitance C65 of the parallel capacitor 65 is selected such that the starting circuit 60 has the above mountain-shaped output characteristics (the output characteristics of the starting circuit 60 become the above mountain-shaped output characteristics).

According to the aforementioned high pressure discharge lamp lighting apparatus of the present embodiment, in contrast to a situation where the starting pulse value Vp monotonically decreases as the length of the output wire 83 increases in a similar manner as seen in the conventional art, it is possible to decrease a width of variation in the starting pulse value Vp caused by varying the length of the output wire 83 in a similar manner as seen in the first embodiment. Therefore, it is possible to reduce an influence given by the output wires 83. Thus, the high pressure discharge lamp 90 can be turned on even if the part of the output wires 83 is relatively long. Additionally, it is possible to prevent the starting pulse value Vp from becoming excessively high even if the pair of the output wires 83 is relatively short.

Especially, the high pressure discharge lamp lighting apparatus 10 utilizes the parallel capacitor 65 to give the above mountain-shaped characteristics to the starting circuit 60. Therefore, according to the high pressure discharge lamp lighting apparatus 10, it is unnecessary to newly add circuits used for giving the above mountain-shaped characteristics to the starting circuit 60.

Also in the high pressure discharge lamp lighting apparatus 10 of the present embodiment, the local maximum point of the parasitic oscillation voltage Vpb is defined as a point in which the primary voltage rising time T (see FIG. 9) and the parasitic oscillation frequency fb are satisfy the relation of T=¼fb. Therefore, in order that the parasitic oscillation voltage Vpb has the local maximum point within the usable range, the relation of T>¼fb1 need be satisfied. When the capacitance n²*C83 of the virtual capacitor obtained when the output wire length L is the shortest within a usable range is Cx and the capacitance C65 of the parallel capacitor 65 is Cp, the relation of T>¼fb1 is represented as the following formula (6) by use of the above formula (4).

$$\begin{matrix}[ Formula 9 ] & \\ T > \frac{1}{2} π \sqrt{LL \times ( \frac{Cx \times Cp}{Cx + Cp} )} & ( 6 )\end{matrix}$$

When the increase amount exceeds the decrease amount, the starting pulse value Vp has the local maximum point with relation to the output wire length L within the usable range. In order that the above increase amount exceeds the above decrease amount, it is sufficient that the capacitance C65 of the parallel capacitor 65 is appropriately selected as mentioned in the above.

The starting circuit 60 is configured such that the starting pulse value Vp falls within a desired range within the usable range. For example, it is assumed that the assumed output wire length L (that is, usable range) is from 0 m to 10 m and a range (“high pressure discharge lamp starting range”) of the starting pulse value Vp necessitated for initiating the high pressure discharge lamp 90 is from 3.5 kV to 5 kV. In this situation, when a socket (not shown) configured to receive the high pressure discharge lamp 90 and the pair of the output wires 83 has a voltage resistance not less than 5 kV, it is sufficient that the capacitance C65 of the parallel capacitor 65 is selected from a range of 10 nF to 22 nF.

Besides, the high pressure discharge lamp lighting apparatus 10 of the present embodiment can be used in the lighting fixture 80 shown in FIG. 2, in a similar fashion as seen in the first embodiment. This point of view is applicable to the following third to fifth embodiments.

### Third Embodiment

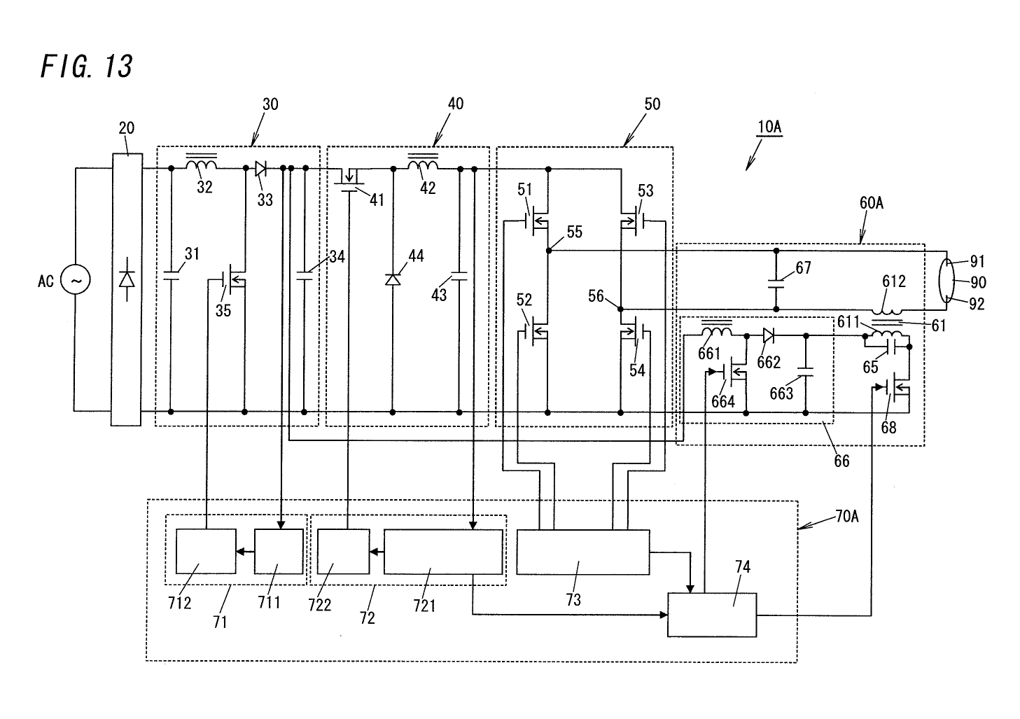

As shown in FIG. 13, the high pressure discharge lamp lighting apparatus 10A of the present embodiment includes the rectification circuit 20, the boost chopper circuit 30, the step-down chopper circuit 40, the polarity reversion circuit 50, the starting circuit 60A, and the control circuit 70A.

The high pressure discharge lamp lighting apparatus 10A is different from the high pressure discharge lamp lighting apparatus 10 of the second embodiment in that the starting circuit 60A is configured to receive power from the boost chopper circuit 30 rather than the polarity reversion circuit 50. Besides, the rectification circuit 20, the boost chopper circuit 30, the step-down chopper circuit 40, and the polarity reversion circuit 50 are the same as those of the first embodiment, and no explanations thereof are deemed necessary.

The starting circuit 60A includes the pulse transformer 61, the parallel capacitor 65, a starting power source 66, a capacitor 67, and a switching element 68.

The starting power source 66 is a boost converter configured to raise the output voltage of the boost chopper circuit 30. The starting power source 66 includes an inductor 661 which has its first end connected to the output terminal of the high voltage side of the boost chopper circuit 30. The inductor 661 has its second end connected to an anode of a diode 662. The diode 662 has its cathode connected to a first end of the output capacitor 663. The output capacitor 663 has its second end connected to the output terminal of the low voltage side of the boost chopper circuit 30. The switching element 664 has its first end connected to a junction of the inductor 661 and the diode 662. The switching element 664 has its second end connected to a junction of the boost chopper circuit 30 and the output capacitor 663. Both ends of the output capacitor 664 define output terminals of the starting power source 66, respectively.

In the high pressure discharge lamp lighting apparatus 10A, the primary coil 611 has its first end connected to the output terminal of a high voltage side of the starting power source 66. Additionally, the primary coil 611 has its second end connected to the output terminal of a low voltage side of the starting power source 66 through the switching element 68. Further, in the starting circuit 60, the capacitor 67 has its first end connected to the first electrode 91 and has its second end connected to the second electrode 92 through the secondary coil 612.

The control circuit 70A includes a starting circuit control unit 74 in addition to the aforementioned boost control unit 71, step-down control unit 72, and polarity reversion drive unit 73. The starting circuit control unit 74 is configured to control the respective switching elements 664 and 68. For example, the starting circuit control unit 74 outputs drive signals to the switching elements 664 and 68, respectively. Upon receiving the drive signal having a high level, the switching elements 664 and 68 are turned on. Upon receiving the drive signal having a low level, the switching elements 664 and 68 are turned off.

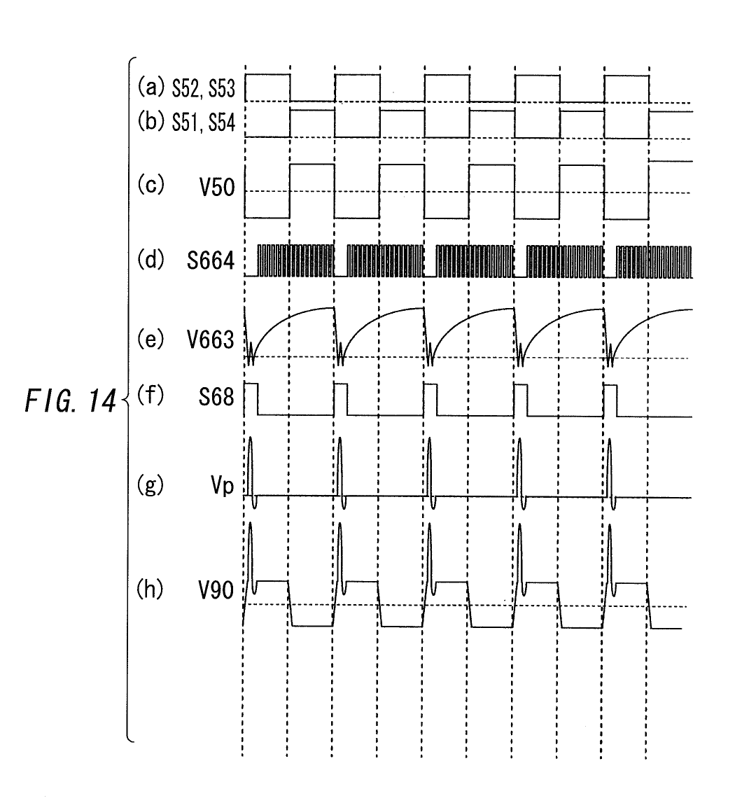

With reference to FIG. 14, an explanation is made to operation of the high pressure discharge lamp lighting apparatus 10A. In FIG. 14, (a) shows a time variation of the drive signals S52 and S53 respectively output to the switching elements 52 and 53. In FIG. 14, (b) shows a time variation of the drive signals S51 and S54 respectively output to the switching elements 51 and 54. In FIG. 14, (c) shows a time variation of the output voltage V50 of the polarity reversion circuit 50. In FIG. 14, (d) shows a time variation of the drive signal S664 output to the switching element 664. In FIG. 14, (e) shows a time variation of a voltage (charging voltage) V663 developed across the output capacitor 663. In FIG. 14, (f) shows a time variation of the drive signal S68 output to the switching element 68. In FIG. 14, (g) shows a time variation of the starting pulse value Vp. In FIG. 14, (h) shows a time variation of the lamp voltage V90.

The starting circuit control unit 74 turns on the switching element 68 in synchronization with a timing at which the polarity reversion drive unit 73 turns on and off the switching elements 51 to 54 of the polarity reversion circuit 50. For example, the starting circuit control unit 74 keeps the switching element 68 turned on only for a predetermined period beginning from the falling of the output voltage V50 of the polarity reversion circuit 50. The predetermined period is shorter than a half of a period of the output voltage V50 of the polarity reversion circuit 50.

During a period in which the switching element 68 is kept turned off, the starting circuit control unit 74 turns on and off the switching element 664 to allow the starting power source 66 to supply a DC power. Thereby, an output voltage (that is, the charging voltage V633 of the output capacitor 663) is gradually increased. Thereafter, the starting circuit control unit 74 turns off the switching element 664 and turns on the switching element 68. Consequently, a voltage (pulse voltage) is applied across the primary coil 611 of the pulse transformer 61. As a result, the secondary voltage V612 is induced across the secondary coil 612, and the starting pulse is applied across the pair of the electrodes 91 and 92 of the high pressure discharge lamp 90.

With regard to the high pressure discharge lamp lighting apparatus 10, when the capacitance C65 of the parallel capacitor 65 has a large value such as 10 nF, it is possible to reduce the influence of the output wire length L on the starting pulse value Vp. However, it is difficult to obtain the starting pulse value Vp which is necessitated for activating the high pressure discharge lamp 90.

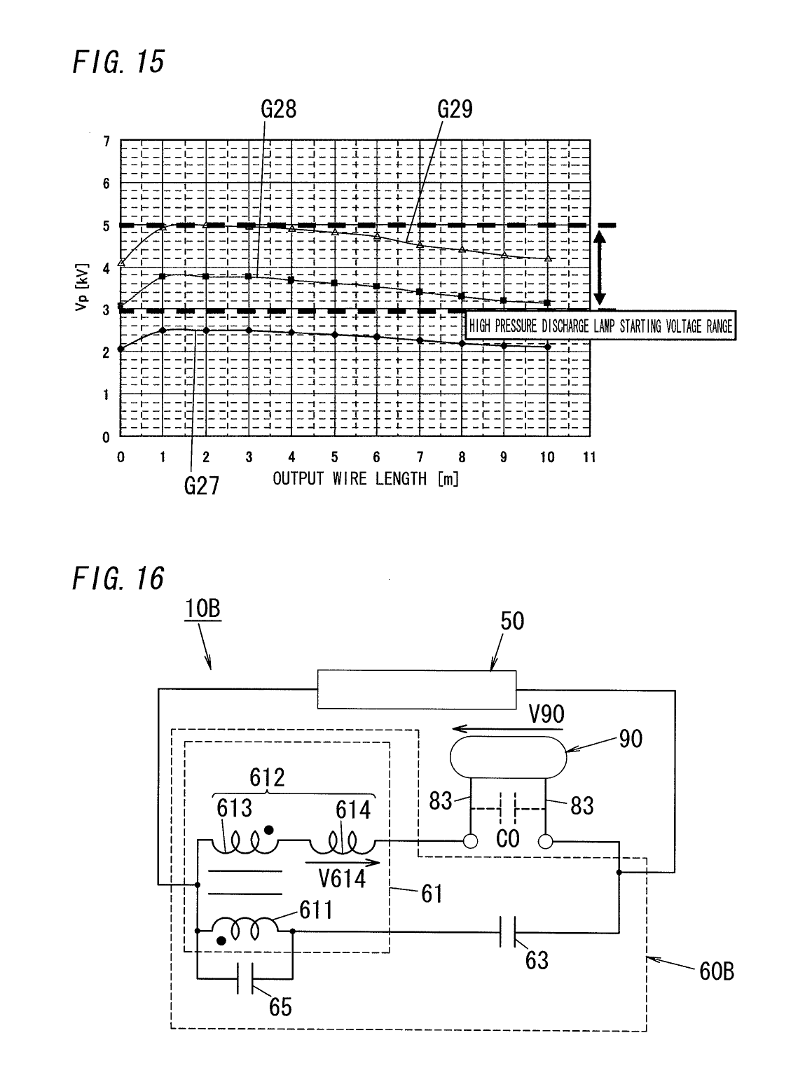

FIG. 15 shows a graph illustrating a relation between the starting pulse value Vp and the output wire length L. In FIG. 15, a lateral axis denotes the output wire length L [m], and a vertical axis denotes the starting pulse value Vp [kV].

In FIG. 15, as mentioned in the second embodiment, the graph G27 indicates the relation in which the parallel capacitor 65 has the capacitance C65 of 100 nF. Likewise, each of graphs G28 and G29 indicates the relation in which the parallel capacitor 65 has the capacitance C65 of 100 nF.

The graph G28 indicates the relation between the starting pulse value Vp and the output wire length L obtained when the peak value VN1 of the primary voltage V611 is 1.5 times greater than that of the graph G27. In other words, the charging voltage V663 of the output capacitor 663 of the starting power source 66 is selected to be 1.5 times greater than the break-over voltage Vs-on of the switching element 62 of the second embodiment. With this arrangement, it is possible to obtain the starting pulse value Vp which is necessitated for activating the high pressure discharge lamp 90 within the range of the output wire length L of 0 m to 10 m.

The graph G29 indicates the relation between the starting pulse value Vp and the output wire length L obtained when the peak value VN1 of the primary voltage V611 is 2 times greater than that of the graph G27. In other words, the charging voltage V663 of the output capacitor 663 of the starting power source 66 is more increased, and is selected to be 2 times greater than the break-over voltage Vs-on of the switching element 62. With this arrangement, it is possible to obtain the starting pulse value Vp which is necessitated for activating the high pressure discharge lamp 90 when the output wire length L is more increased (the pair of the output wires 83 is more extended).

As described in the above, the high pressure discharge lamp lighting apparatus 10A is enabled to increase the peak voltage VN1 of the primary voltage V611 of the pulse transformer 61 even if the capacitance C65 of the parallel capacitor 65 increases, because of that the charging voltage V663 of the output capacitor 663 is kept raised when the switching element 68 is turned on.

Thus, according to the high pressure discharge lamp lighting apparatus 10A of the present embodiment, it is possible to reduce the influence caused by the output wire length L on the starting pulse value Vp yet to increase the starting pulse value Vp. As a result, it is possible to prevent a deterioration of the starting performance of the high pressure discharge lamp 90 resulting from an increase of the capacitance C65 of the parallel capacitor 65.

### Fourth Embodiment

As shown in FIG. 16, the high pressure discharge lamp lighting apparatus 10B is different in a configuration of the starting circuit 60B from the high pressure discharge lamp lighting apparatus 10 of the first embodiment. Although a part of the high pressure discharge lamp lighting apparatus is not illustrated in FIG. 16, the high pressure discharge lamp lighting apparatus 10B includes the rectification circuit 20, the boost chopper circuit 30, the step-down chopper circuit 40, the polarity reversion circuit 50, and the control circuit 70 in a similar fashion as seen in the high pressure discharge lamp lighting apparatus 10 of the first embodiment.

The starting circuit 60B is different from the starting circuit 60 of the first embodiment in that the starting circuit 60B includes no switching element 62 and resistor 64.

With respect to the fourth and fifth embodiments, the secondary coil 612 of the pulse transformer 61 is defined as a series circuit of an effective inductor 613 and a leak inductor 614. The effective inductor 613 is defined as a virtual inductor corresponding to an effective inductance of the secondary coil 612. The leak inductor 614 is defined as a virtual inductor corresponding to a leak inductance (that is, an inductance component of leak impedance) of the secondary coil 612.

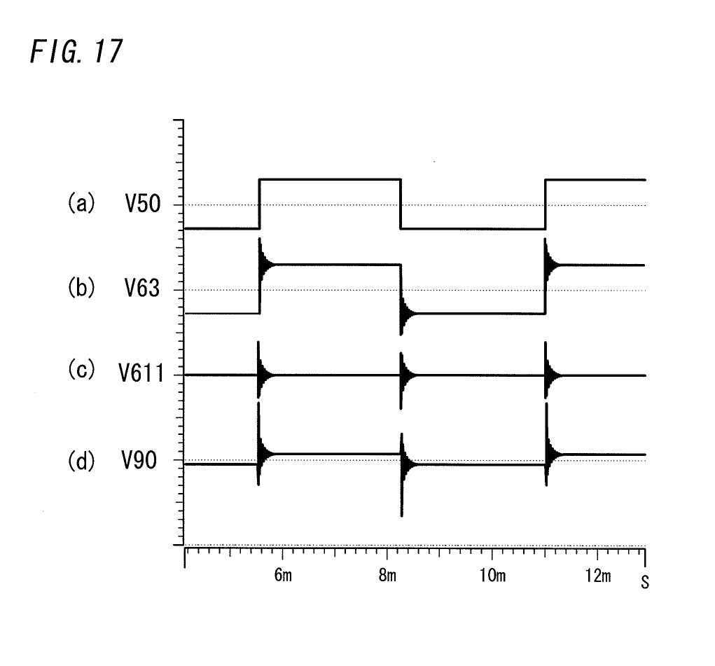

In FIG. 17, (a) shows a time variation of the output voltage V50 of the polarity reversion circuit 50. In FIG. 17, (b) shows a time variation of the charging voltage V63 of the series capacitor 63. In FIG. 17, (c) shows a time variation of the primary voltage V611. In FIG. 17, (d) shows a time variation of the lamp voltage V90.

As shown in FIG. 17, normally, the primary voltage V611 has an absolute value smaller than an absolute value of the output voltage V50 of the polarity reversion circuit 50. However, the charging voltage V63 of the series capacitor 63 is added to the primary voltage V611 just after the switching elements 51 to 54 of the polarity reversion circuit 50 are switched. In this situation, the primary voltage V611 has an absolute value 2 times greater than the absolute value of the output voltage V50 of the polarity reversion circuit 50.

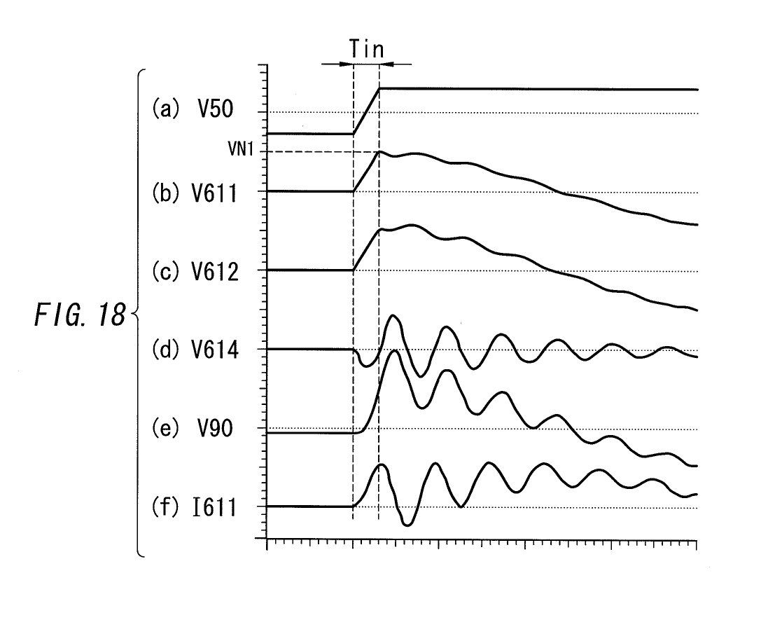

FIG. 18 shows an explanatory view illustrating operation of the high pressure discharge lamp lighting apparatus 10B before and after the switching elements 51 to 54 of the polarity reversion circuit 50 are switched. In FIG. 18, (a) shows a time variation of the output voltage V50 of the polarity reversion circuit 50. In FIG. 18, (b) shows a time variation of the primary voltage V611. In FIG. 18, (c) shows a time variation of the secondary voltage V612. In FIG. 18, (d) shows a time variation of a voltage (hereinafter referred to as “parasitic oscillation voltage”) V614 considered as a voltage across the leak inductor 614. In FIG. 18, (e) shows a time variation of the lamp voltage V90. In FIG. 18, (f) shows a time variation of a current I611 flowing through the primary coil 611.

As apparent from FIG. 18, it takes a certain time (rising time) T to increase the primary voltage V611 from 0 to the peak value VN1. In the starting circuit 60B, the rising time T is approximately identical to a time Tin necessitated for increasing the output voltage (that is, input voltage of the starting circuit 60B) V50 of the polarity reversion circuit 50 from 0 to a peak value.

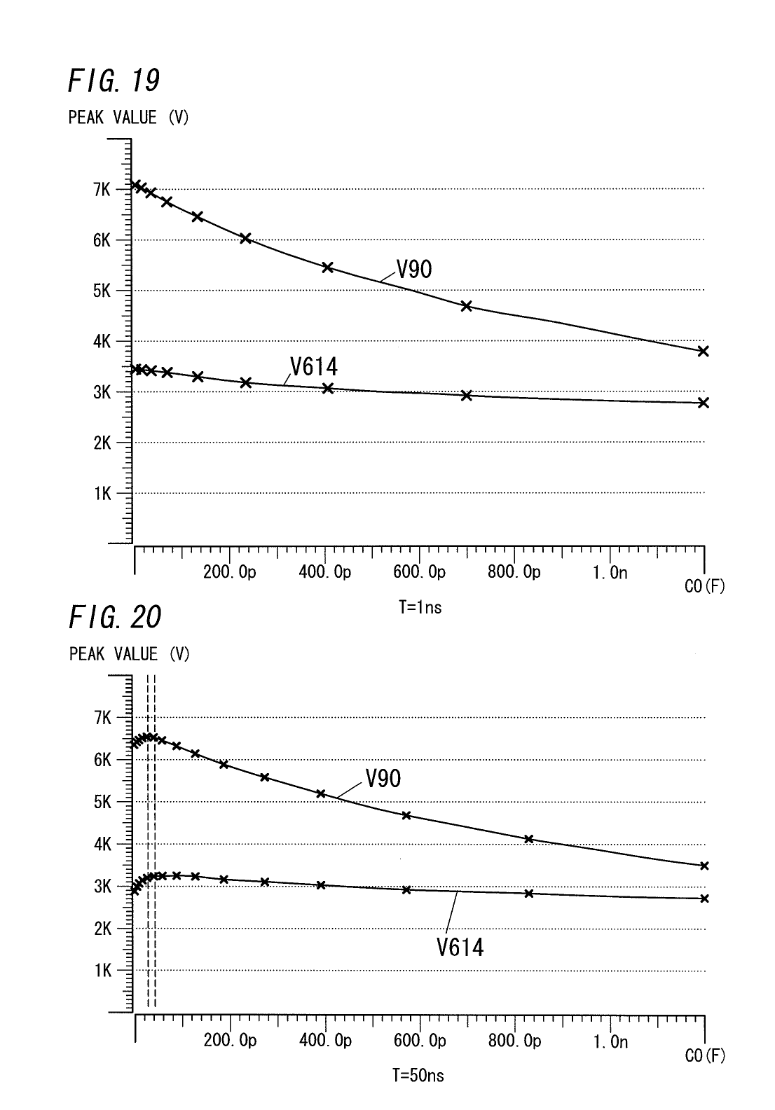

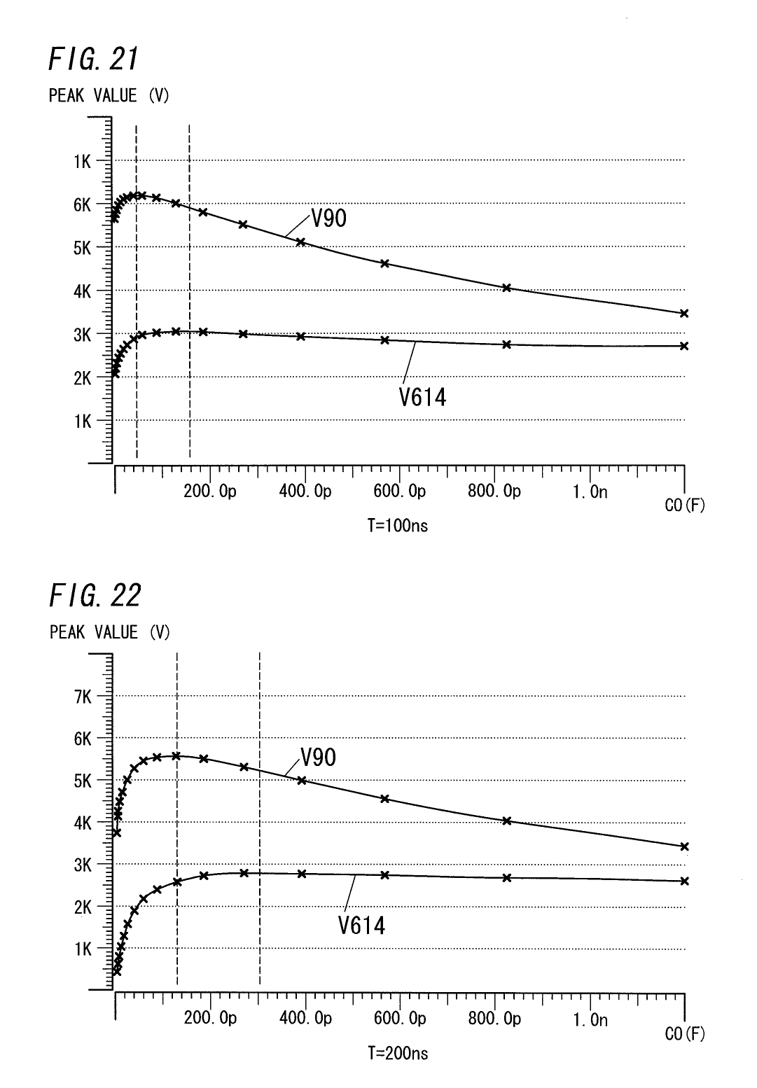

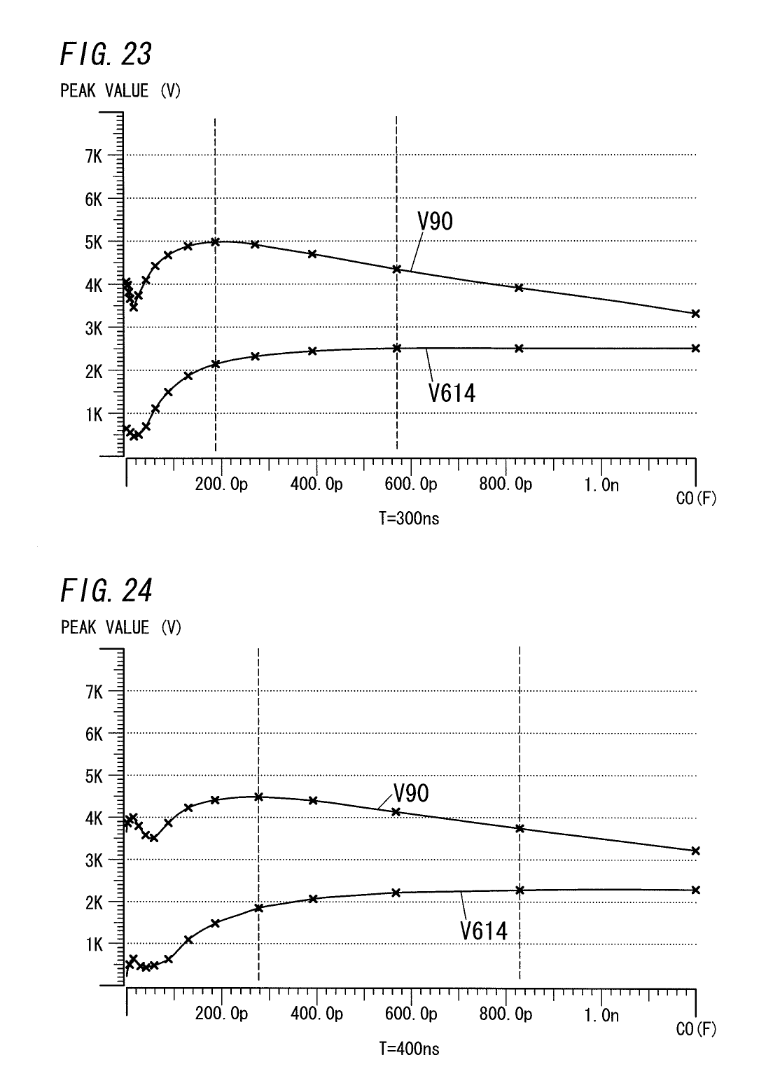

With respect to six instances having the different rising times T, FIGS. 19 to 24 illustrate individual behaviors of the wiring capacitance C83 as well as a peak value of the lamp voltage V90 in relation to a peak (hereinafter referred to as “parasitic pulse value”) of the parasitic oscillation voltage V614. FIGS. 19 to 24 show the relation with the rising time T of 1 ns, 50 ns, 100 ns, 200 ns, 300 ns, and 400 ns, respectively.

The wiring capacitance C83 monotonically increases with an increase of the output wire length L. The peak value of the lamp voltage V90 is corresponding to the starting pulse value Vp. Therefore, FIGS. 19 to 24 also illustrate individual behaviors of the starting pulse value Vp as well as the parasitic pulse value in relation to the output wire length L. As apparent from FIGS. 19 to 24, at least when the rising time T is 50 ns or more, the starting pulse value Vp and the parasitic pulse value obviously increase as the output wire length L increases, and the starting pulse value Vp and the parasitic pulse value decrease when the output wire length L exceeds a certain value. In other words, each of the starting pulse Vp and the parasitic pulse value has a local maximum value (local maximum point).

The lamp voltage V90 includes a component having its peak approximately monotonically decreased with an increase of the wiring capacitance C83, and the parasitic oscillation voltage V614 superimposed on the component. Therefore, the starting pulse value Vp has a local maximum point positioned in left side (side in which the output wire length L and the wiring capacitance C83 decrease) of a local maximum point of the parasitic pulse value. In order to give the above local maximum point to the starting pulse value Vp with the output wire length L falling in the usable range, the following condition need be satisfied. That is, the shortest value of the output wire length L within the usable range is required to be shorter than the output wire length L corresponding to the local maximum point of the parasitic pulse value.

When T is equivalent to ¼fk, the parasitic oscillation voltage V614 has maximum amplitude. Besides, fk denotes a frequency (hereinafter referred to as “parasitic oscillation frequency”) of the parasitic oscillation voltage 614, and T denotes the rising time. A value of ¼fk monotonically increases with an increase of the wiring capacitance C83 (that is, the output wire length L).

Therefore, for satisfying the above condition, T must exceed ¼fk when the output wire length L is the shortest within the usable range. The parasitic oscillation frequency fk can be represented by the following formula (7). In the following formula (7), Cx denotes a capacitance of a capacitive component assumed to be connected in parallel with the primary coil 611 of the pulse transformer 61, and LL denotes the leak inductance of the pulse transformer 61.

$$\begin{matrix}[ Formula 10 ] & \\ fk \approx \frac{1}{2 π \sqrt{LL \times Cx}} & ( 7 )\end{matrix}$$

By use of the above formula (7), T>¼fk can be represented by the following formula (8).

$$\begin{matrix}[ Formula 11 ] & \\ T > \frac{1}{2} π \sqrt{LL \times Cx} & ( 8 )\end{matrix}$$

As described in the first embodiment, the capacitance Cx can be considered as a capacitance of the series circuit of the virtual capacitor and the parallel capacitor 65. Additionally, a capacitance of the virtual capacitor can be considered as n²*C83.

Since the local maximum point of the starting pulse value Vp moves toward the right side (that is, side in which the output wire 83 becomes long) as the rising time T increases, it is possible to more restrain a decrease of the starting pulse value Vp caused by an increase of the output wire 83. However, the overall starting pulse value Vp decreases with an increase of the rising time T. Therefore, in the instances of each of FIGS. 19 to 24, the rising time T is preferred to be around 300 ns, for example.

As mentioned in the above, in the high pressure discharge lamp lighting apparatus 10B of the present embodiment, the rising time T is selected such that the starting circuit 60B has the above mountain-shaped characteristics.

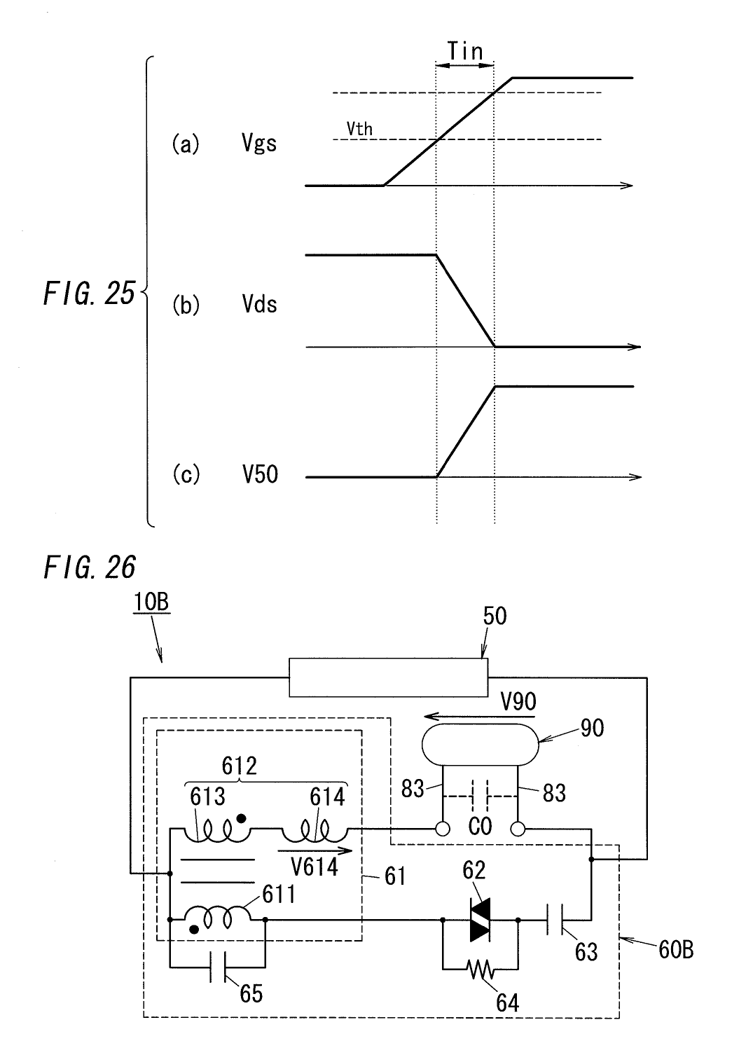

With respect to the high pressure discharge lamp lighting apparatus 10B, the switching elements 51 to 54 of the polarity reversion circuit 50 are electric field effect transistors. With regard to the switching elements 51 to 54, as shown in FIG. 25, while a gate-source voltage (hereinafter referred to as “gate voltage”) Vgs is not less than a predetermined threshold voltage Vth, impedance between drain and source monotonically decreases down to about 0 with an increase of the gate voltage Vgs.

Therefore, in a situation where the switching elements 51 to 54 are turned on, if the gate voltage Vgs is gradually increased, a voltage (that is, drain-source voltage) Vds across the switching elements 51 to 54 is gradually decreased. Therefore, it is possible to gradually vary the output voltage V50 of the polarity reversion circuit 50. In other words, the time Tin (that is, the rising time T) can be adjusted by varying a speed at which the polarity reversion drive unit 73 increases the gate voltage Vgs of each of the switching elements 51 to 54.

In the high pressure discharge lamp lighting apparatus 10B of the present embodiment, the polarity reversion drive unit 73 is configured to gradually increase a potential applied to a gate of each of the switching elements 51 to 54 to adjust the rising time T to a predetermined time (time allowing the starting circuit 60 to have the above mountain-shaped characteristics). Additionally, in the high pressure discharge lamp lighting apparatus 10B of the present embodiment, the control circuit 70 acts as a voltage increase means configured to increase the primary voltage V611 of the pulse transformer 611 such that the rising time T becomes identical to the predetermined time.

FIG. 26 shows a modification of the high pressure discharge lamp lighting apparatus 10B of the present embodiment. The starting circuit 60B of the modification includes the parallel circuit of the switching element 62 and the resistor 64 in a similar manner as seen in the starting circuit 60 of the first embodiment.

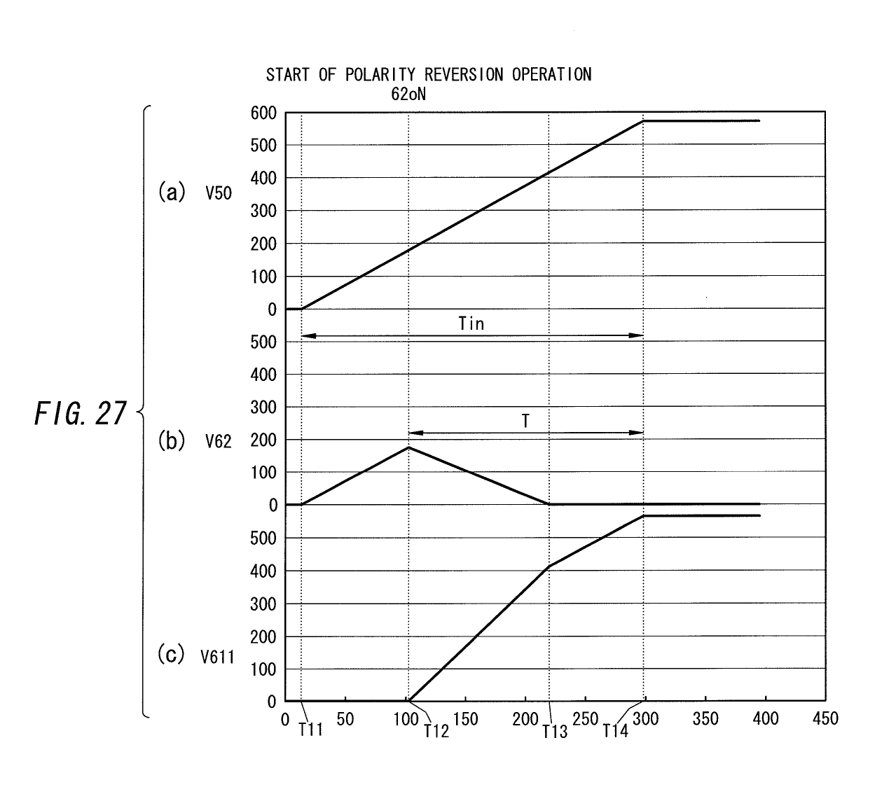

FIG. 27 is an explanatory view of operation of the modification. In FIG. 27, (a) shows a time variation of the output voltage V50 of the polarity reversion circuit 50. In FIG. 27, (b) shows a time variation of the voltage V62 across the switching element 62. In FIG. 27, (c) shows a time variation of the primary voltage V611. Besides, the time T11 in FIG. 27 indicates a time at which the polarity reversion circuit 50 starts a polarity reversion operation.

As shown in FIG. 27, the primary voltage V611 does not increase until the output voltage V50 reaches the break-over voltage of the switching element 62 (until the time T12). Therefore, the rising time T is shorter than the time Tin. Upon turning on, the switching element 62 gradually decreases its impedance down to a lowest value (about 0) in response to an increase of the output voltage V50. Additionally, a time (time T13) at which the impedance of the switching element 62 reaches the lowest value is prior to a time (time T14) at which the output voltage V50 reaches its peak value. Whereby, during the first period (T12 to T13) within which the switching element 62 lowers its impedance to minimum, the primary voltage V611 increases at a high rate than is made during a second period (T13 to T14) which follows the first period and within which the polarity reversion circuit 50 raises its output voltage V50 to its peak.

Besides, operation of gradually increasing the gate voltage Vgs may be performed only during the starting period of the high pressure discharge lamp 90. Therefore, once after the step-down drive unit 722 determines that the high pressure discharge lamp 90 is turned on (that is, while the high pressure discharge lamp 90 is turned on), the polarity reversion drive unit 73 may accelerate the rising speed of the gate voltage Vgs than at the starting period. With this arrangement, it is possible to reduce a power consumption of the high pressure discharge lamp lighting apparatus 10B.

### Fifth Embodiment

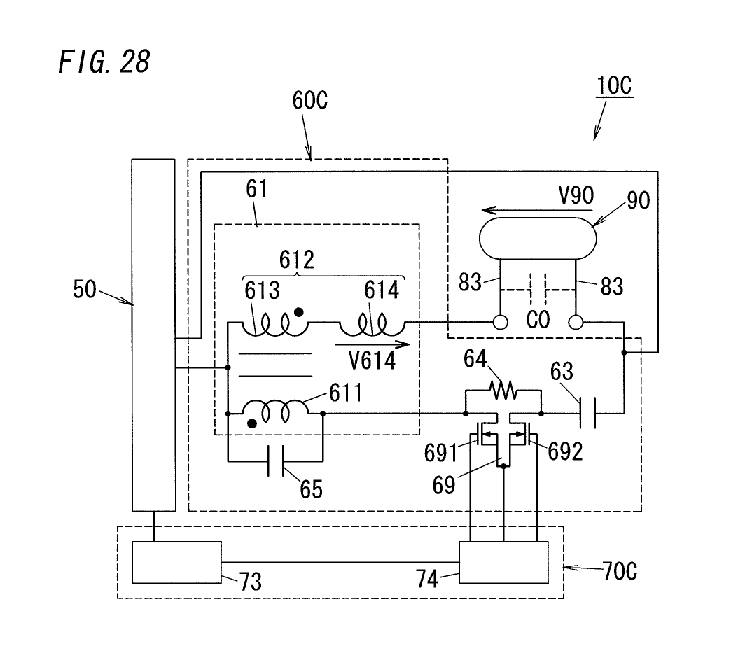

As shown in FIG. 28, the high pressure discharge lamp lighting apparatus 10C of the present embodiment is different in the starting circuit 60C and the control circuit 70C from the fourth embodiment. Since the rectification circuit 20, boost chopper circuit 30, and step-down chopper circuit 40 of the present embodiment are the same as those of the first or fourth embodiment, and no explanation and drawings thereof are deemed necessary. Besides, the boost control unit 71 and step-down control unit 72 of the control circuit 70C are not shown in FIG. 28.

The starting circuit 60C is different from the starting circuit 60B shown in FIG. 26 in that the starting circuit 60C includes a variable impedance circuit 69 instead of the switching element 62.

The variable impedance circuit 69 is a series circuit of two switching elements 691 and 692. The switching element 691 has it source electrode connected to a source electrode of the switching element 692. The switching element 691 has it drain electrode connected to the primary coil 611. Thereby, the variable impedance circuit 69 is connected in series with the primary coil 611. Further, the switching element 692 has it drain electrode connected to the series capacitor 63.

The control circuit 70C includes the starting control unit 74. The starting control unit 74 is configured to turn on and off the switching elements 691 and 692 in synchronization with the operation of the polarity reversion drive unit 73.

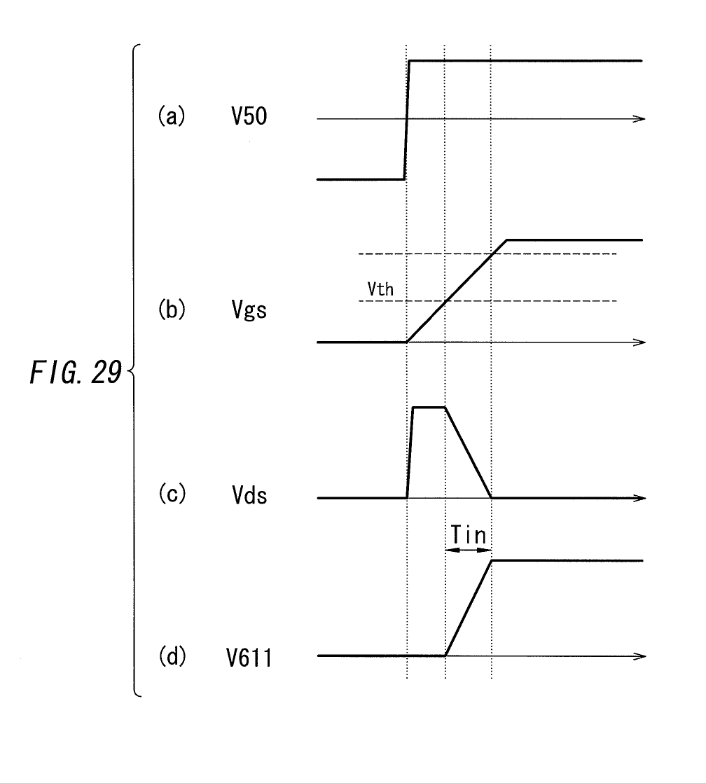

FIG. 29 is an explanatory view illustrating operation of the high pressure discharge lamp lighting apparatus 10C of the present embodiment. In FIG. 29, (a) shows a time variation of the output voltage V50 of the polarity reversion circuit 50. In FIG. 29, (b) shows a time variation of the gate-source voltage Vgs concerning the respective switching elements 691 and 692. In FIG. 29, (c) shows a time variation of the drain-source voltage Vds concerning the respective switching elements 691 and 692. In FIG. 29, (d) shows a time variation of the primary voltage V611.

As shown in (b) of FIG. 14, each of the switching elements 691 and 692 has similar characteristics to the above switching elements 51 to 54.

The starting control unit 74 starts on-operation at a timing at which the output voltage V50 of the polarity reversion circuit 50 is reversed. The on-operation is defined as operation in which the starting control unit 74 gradually increases the gate-source voltage Vgs of each of the switching elements 691 and 692. The on-operation is completed when the respective switching elements 691 and 692 are completely turned on (when the respective switching elements 691 and 692 have its impedance of approximately 0).

After completion of the on-operation, the starting control unit 74 turns off the respective switching elements 691 and 692 when the current flowing through the primary coil 611 becomes approximately 0.

In the high pressure discharge lamp lighting apparatus 10C, the rising time T is varied depending on a speed at which the starting control unit 74 increases the gate-source voltages Vgs of the switching elements 691 and 692 during the on-operation.

Accordingly, the control circuit 70C is configured to control the variable impedance circuit 69 so that the rising time T becomes equivalent to a predetermined time (time allowing the starting circuit 60C to have the above mountain-shaped characteristics).

In the high pressure discharge lamp lighting apparatus 10C of the present embodiment, differently from the fourth embodiment, it is unnecessary to adjust the speed of an increase of the gate voltage Vgs with relation to the switching elements 51 to 54 of the polarity reversion circuit 50. Therefore, according to the high pressure discharge lamp lighting apparatus 10C, in comparison with the fourth embodiment, it is possible to reduce power consumption at the switching elements 51 to 54 of the polarity reversion circuit 50.

Besides, the timing of starting the on-operation need not be strictly identical to the timing of reversion of the output voltage V50 of the polarity reversion circuit 50, but may slightly delay from the timing of the reversion. Additionally, in the on-operation, both the gate-source voltages Vgs of the two switching elements 691 and 692 are not necessarily increased. For example, it is equally possible to give an increased gate-source voltage Vgs to a high-voltage-side one of the switching elements 691 and 692 in accordance with the polarity of the output voltage V50 of the polarity reversion circuit 50.

1. A high pressure discharge lamp lighting apparatus comprising:
a power circuit including a pair of output terminals adapted to be respectively connected to a pair of electrodes of a high pressure discharge lamp, said power circuit being configured to apply an AC voltage for keeping said high pressure discharge lamp turned on across said pair of said output terminals; and
a starting circuit configured to apply a starting pulse voltage across said pair of said electrodes of said high pressure discharge lamp,
wherein said starting circuit is configured to have output characteristics of increasing the starting pulse voltage with an increase of a length of a pair of output wires used with connection of said high pressure discharge lamp, and of decreasing the starting pulse voltage when the length of said pair of said output wires exceeds a certain value.

2. A high pressure discharge lamp lighting apparatus as set forth in claim 1, wherein
said starting circuit includes a pulse transformer, and is configured to apply, across said pair of said electrodes of said high pressure discharge lamp, a secondary voltage of said pulse transformer as the starting pulse voltage, said secondary voltage being obtained when a primary voltage of said pulse transformer is equivalent to a predetermined value, and
said pulse transformer being configured to have a turn ratio and a coupling coefficient selected such that said starting circuit has said output characteristics.

3. A high pressure discharge lamp lighting apparatus as set forth in claim 2, wherein
said high pressure discharge lamp lighting apparatus is configured to satisfy the following formula:
$$\frac{N 2}{N 1} < \frac{Vpm}{V N 1}$$
wherein
N1 denotes the number of turns of a primary coil of said transformer, and
N2 denotes the number of turns of a secondary coil of said transformer, and
Vpm denotes a central value of a range of a specified value of the starting pulse voltage necessitated for starting said high pressure discharge lamp, and
VN1 denotes the predetermined value.

4. A high pressure discharge lamp lighting apparatus as set forth in claim 3, wherein
said high pressure discharge lamp lighting apparatus is configured to satisfy the following formula:
$$T > \frac{1}{2} π \sqrt{LL \times Cx}$$
wherein
Cx denotes capacitance of a capacitive component considered to be connected in parallel with said primary coil of said pulse transformer, and
LL denotes a leakage inductance of said pulse transformer, and
T denotes a time necessitated for increasing the primary voltage from 0 to the predetermined value during a starting period of said high pressure discharge lamp.

5. A high pressure discharge lamp lighting apparatus as set forth in claim 1, wherein
said starting circuit includes a pulse transformer, and a parallel capacitor connected across a primary coil of said pulse transformer, said starting circuit being configured to apply, across said pair of said electrodes of said high pressure discharge lamp, a secondary voltage of said pulse transformer as the starting pulse voltage, said secondary voltage being obtained when a primary voltage of said pulse transformer is equivalent to a predetermined value, and
said parallel capacitor being configured to have a capacitance selected such that said starting circuit has said output characteristics.

6. A high pressure discharge lamp lighting apparatus as set forth in claim 5, wherein
said high pressure discharge lamp lighting apparatus is configured to satisfy the following formula:
$$T > \frac{1}{2} π \sqrt{LL \times ( \frac{Cx \times Cp}{Cx + Cp} )}$$
wherein
Cp denotes capacitance of said parallel capacitor, and
Cx denotes capacitance of a virtual capacitor which is connected in series with said parallel capacitor and in parallel with said primary coil of said pulse transformer, and which is an equivalent circuit of a capacitive component between said pair of said output wires having the shortest length within a usable range, and
LL denotes a leakage inductance of said pulse transformer, and
T denotes a time necessitated for increasing the primary voltage from 0 to the predetermined value during a starting period of said high pressure discharge lamp.

7. A high pressure discharge lamp lighting apparatus as set forth in claim 1, wherein
said starting circuit includes a pulse transformer, said starting circuit being configured to apply, across said pair of said electrodes of said high pressure discharge lamp, a secondary voltage of said pulse transformer as the starting pulse voltage, said secondary voltage being obtained when a primary voltage of said pulse transformer is equivalent to a predetermined value,
said high pressure discharge lamp lighting apparatus comprising a voltage increasing means, and said voltage increasing means being configured to increase the primary voltage of said pulse transformer to adjust a time for increasing the primary voltage from 0 to the predetermined value such that said starting circuit has said output characteristics.

8. A high pressure discharge lamp lighting apparatus as set forth in claim 7, wherein
said voltage increasing means includes a variable impedance circuit connected in series with a primary coil of said pulse transformer, and a control circuit configured to control said variable impedance circuit and,
said control circuit being configured to control said variable impedance circuit to adjust the time for increasing the primary voltage from 0 to the predetermined value such that said starting circuit has said output characteristics.

9. A high pressure discharge lamp lighting apparatus as set forth in claim 7, wherein
said power circuit includes a DC power circuit configured to output a DC current, and an inverter circuit of a full-bridge type composed of electric field effect transistors,
said inverter circuit being configured to convert the DC current obtained from said DC power circuit into a square wave AC current of which polarity is reversed at a predetermined frequency, and provide the resultant square wave AC current to said high pressure discharge lamp and a primary coil of said pulse transformer,
said voltage increasing means including a control circuit configured to control said electric field effect transistor of said inverter circuit, and
said control circuit being configured to gradually increase a voltage applied to a gate of said electric field effect transistor, in order to adjust the time for increasing the primary voltage from 0 to the predetermined value such that said starting circuit has said output characteristics.

10. A high pressure discharge lamp lighting apparatus as set forth in claim 7, wherein
said high pressure discharge lamp lighting apparatus is configured to satisfy the following formula:
$$T > \frac{1}{2} π \sqrt{LL \times Cx}$$
wherein
Cx denotes capacitance of a capacitive component considered to be connected in parallel with a primary coil of said pulse transformer, and
LL denotes a leakage inductance of said pulse transformer, and
T denotes a time necessitated for increasing the primary voltage from 0 to the predetermined value during a starting period of said high pressure discharge lamp.

11. A high pressure discharge lamp lighting apparatus as set forth in claim 1, wherein
said starting circuit is configured to, while said pair of said output wires has a length within a usable range, output the starting pulse voltage exceeding a starting voltage of said high pressure discharge lamp.

12. A high pressure discharge lamp lighting apparatus as set forth in claim 1, wherein
said starting circuit is designed such that a difference between the starting pulse voltage output when said pair of said output wires have the shortest length within the usable range and the starting pulse voltage output when said pair of said output wires have the longest length within the range does not exceed 500V.

13. A high pressure discharge lamp lighting apparatus as set forth in claim 1, wherein
said starting circuit is designed such that the certain value is not greater than the shortest length of said pair of said output wires within a usable range.

14. A lighting fixture comprising said high pressure discharge lighting apparatus defined by claim 1, and a main fixture body configured to carry said high pressure discharge lamp lighting apparatus.

15. A high pressure discharge lamp lighting apparatus as set forth in claim 2, wherein
said starting circuit is configured to, while said pair of said output wires has a length within a usable range, output the starting pulse voltage exceeding a starting voltage of said high pressure discharge lamp.

16. A high pressure discharge lamp lighting apparatus as set forth in claim 2, wherein
said starting circuit is designed such that a difference between the starting pulse voltage output when said pair of said output wires have the shortest length within the usable range and the starting pulse voltage output when said pair of said output wires have the longest length within the range does not exceed 500V.

17. A high pressure discharge lamp lighting apparatus as set forth in claim 2, wherein
said starting circuit is designed such that the certain value is not greater than the shortest length of said pair of said output wires within a usable range.

18. A lighting fixture comprising said high pressure discharge lighting apparatus defined by claim 2, and a main fixture body configured to carry said high pressure discharge lamp lighting apparatus.

19. A high pressure discharge lamp lighting apparatus as set forth in claim 5, wherein
said starting circuit is configured to, while said pair of said output wires has a length within a usable range, output the starting pulse voltage exceeding a starting voltage of said high pressure discharge lamp.

20. A high pressure discharge lamp lighting apparatus as set forth in claim 5, wherein
said starting circuit is designed such that a difference between the starting pulse voltage output when said pair of said output wires have the shortest length within the usable range and the starting pulse voltage output when said pair of said output wires have the longest length within the range does not exceed 500V.

21. A high pressure discharge lamp lighting apparatus as set forth in claim 5, wherein
said starting circuit is designed such that the certain value is not greater than the shortest length of said pair of said output wires within a usable range.

22. A lighting fixture comprising said high pressure discharge lighting apparatus defined by claim 5, and a main fixture body configured to carry said high pressure discharge lamp lighting apparatus.

23. A high pressure discharge lamp lighting apparatus as set forth in claim 7, wherein
said starting circuit is configured to, while said pair of said output wires has a length within a usable range, output the starting pulse voltage exceeding a starting voltage of said high pressure discharge lamp.

24. A high pressure discharge lamp lighting apparatus as set forth in claim 7, wherein
said starting circuit is designed such that a difference between the starting pulse voltage output when said pair of said output wires have the shortest length within the usable range and the starting pulse voltage output when said pair of said output wires have the longest length within the range does not exceed 500V.

25. A high pressure discharge lamp lighting apparatus as set forth in claim 7, wherein
said starting circuit is designed such that the certain value is not greater than the shortest length of said pair of said output wires within a usable range.

26. A lighting fixture comprising said high pressure discharge lighting apparatus defined by claim 7, and a main fixture body configured to carry said high pressure discharge lamp lighting apparatus.
